(19) United States
(12) Patent Application Publication
(10) Pub. No.: US 2014/0133015 A1
(43) Pub. Date: May 15, 2014

(54) IMAGE CAPTURING SYSTEM LENS ASSEMBLY

(71) Applicant: LARGAN PRECISION CO., LTD., Taichung (TW)

(72) Inventors: Chun-Che Hsueh, Taichung (TW); Wei-Yu Chen, Taichung (TW)

(73) Assignee: LARGAN PRECISION CO., LTD., Taichung (TW)

(21) Appl. No.: 13/803,401

(22) Filed: Mar. 14, 2013

(30) Foreign Application Priority Data
Nov. 9, 2012 (TW) 101141891

(51) Int. Cl. G02B 13/18; G02B 13/14

(52) U.S. Cl. CPC G02B 13/18; G02B 13/14
USPC 359/357; 359/715

(57) ABSTRACT

An image capturing system lens assembly includes, in order from an object side to an image side, a first lens element, a second lens element, a third lens element and a fourth lens element. The first lens element with positive refractive power has a convex object-side surface and a convex image-side surface. The second lens element has positive refractive power. The third lens element has positive refractive power. The fourth lens element with positive refractive power has a convex object-side surface and an image-side surface being concave at a paraxial region and convex away from the paraxial region. The fourth lens element has both of the object-side surface and the image-side surface being aspheric.

### CROSS-REFERENCE TO RELATED APPLICATIONS

This non-provisional application claims priority under 35 U.S.C. §119(a) on Patent Application No(s). 101141891 filed in Taiwan, R.O.C. on Nov. 9, 2012, the entire contents of which are hereby incorporated by reference.

### BACKGROUND

1. Technical Field

The disclosure relates to an image capturing system lens assembly, and more particularly to an image capturing system lens assembly applicable to electronic products and infrared photography.

2. Description of Related Art

In recent years, with the popularity of mobile products with camera functionalities, the demand for a miniaturized optical lens system is increasing. The sensor of a conventional photographing camera is typically a CCD (Charge-Coupled Device) image sensor or a CMOS (Complementary Metal-Oxide-Semiconductor) sensor. As the advanced semiconductor manufacturing technologies have allowed the pixel size of sensors to be reduced and compact optical lens systems have gradually evolved toward the field of higher megapixels, there is an increasing demand for compact optical lens systems featuring better image quality.

A conventional compact optical lens system in a portable electronic product mainly adopts a three-element lens structure, such as the one disclosed in U.S. Pat. No. 7,564,635. Due to the popularity of mobile products with high-end specifications, requirements of higher megapixels and better image quality have increased rapidly. However, the conventional optical lens systems cannot satisfy the requirements of high-end mobile products with camera functionalities. Although there are optical lens systems with four-element lens structure, such as the one disclosed in U.S. Patent No. 2012/0099009. The image quality of this optical lens system is better, but the positive refractive power of the optical lens system does not have the balanced distribution and a lens element with negative refractive power is included such that it is not favorable for shortening total track length of the optical lens systems, which leads to limit the application of the compact optical lens system.

On the other hand, an infrared motion capturing photography technology has been developed for smart televisions or motion gaming devices, with features of capturing and recognizing the video of user motions by the infrared photography. Therefore, the demand for the miniaturized optical lens system applicable to infrared wavelength range has increased. In view of this discussion, the industry needs an image capturing system lens assembly having better image quality, short total length and low aberration as well as applicable to general photography and infrared photography.

### SUMMARY

According to one aspect of the disclosure, an image capturing system lens assembly comprises, in order from an object side to an image side, a first lens element, a second lens element, a third lens element and a fourth lens element. The first lens element with positive refractive power has a convex object-side surface and a convex image-side surface. The second lens element has positive refractive power. The third lens element has positive refractive power. The fourth lens element with positive refractive power has a convex object-side surface and an image-side surface being concave at a paraxial region and convex away from the paraxial region. The fourth lens element has both of the object-side surface and the image-side surface being aspheric. A curvature radius of the object-side surface of the first lens element is R1, and a curvature radius of the image-side surface of the first lens element is R2, the following relationship is satisfied:

−0.45<(R1+R2)/(R1−R2)<0.85.

According to another aspect of the disclosure, an image capturing system lens assembly comprises, in order from an object side to an image side, a first lens element, a second lens element, a third lens element and a fourth lens element. The first lens element with positive refractive power has a convex image-side surface. The second lens element has positive refractive power. The third lens element has positive refractive power. The fourth lens element with positive refractive power has a convex object-side surface and an image-side surface being concave at a paraxial region and convex away from the paraxial region. The fourth lens element has both of the object-side surface and the image-side surface being aspheric. A curvature radius of the object-side surface of the first lens element is R1, a curvature radius of the image-side surface of the first lens element is R2, an axial distance between the second lens element and the third lens element is T23, and a focal length of the image capturing system lens assembly is f, the following relationships are satisfied:

−0.45<(R1+R2)/(R1−R2)<1.5; and

0<T23/f<0.40.

### BRIEF DESCRIPTION OF THE DRAWINGS

The disclosure can be more fully understood by reading the following detailed description of the embodiment, with reference made to the accompanying drawings as follows:

FIG. 1 is a schematic view of an image capturing system lens assembly according to a first embodiment of the disclosure;

FIG. 2 shows spherical aberration curves, astigmatic field curves and a distortion curve of the image capturing system lens assembly according to a first embodiment;

FIG. 3 is a schematic view of an image capturing system lens assembly according to a second embodiment of the disclosure;

FIG. 4 shows spherical aberration curves, astigmatic field curves and a distortion curve of the image capturing system lens assembly according a second embodiment;

FIG. 5 is a schematic view of an image capturing system lens assembly according to a third embodiment of the disclosure;

FIG. 6 shows spherical aberration curves, astigmatic field curves and a distortion curve of the image capturing system lens assembly according to a third embodiment;

FIG. 7 is a schematic view of an image capturing system lens assembly according to a fourth embodiment of the disclosure;

FIG. 8 shows spherical aberration curves, astigmatic field curves and a distortion curve of the image capturing system lens assembly according to a fourth embodiment;

FIG. 9 is a schematic view of an image capturing system lens assembly according to a fifth embodiment of the disclosure;

FIG. 10 shows spherical aberration curves, astigmatic field curves and a distortion curve of the image capturing system lens assembly according to a fifth embodiment;

FIG. 11 is a schematic view of an image capturing system lens assembly according to a sixth embodiment of the disclosure;

FIG. 12 shows spherical aberration curves, astigmatic field curves and a distortion curve of the image capturing system lens assembly according to a sixth embodiment;

FIG. 13 is a schematic view of an image capturing system lens assembly according to a seventh embodiment of the disclosure;

FIG. 14 shows spherical aberration curves, astigmatic field curves and a distortion curve of the image capturing system lens assembly according to a seventh embodiment;

FIG. 15 is a schematic view of an image capturing system lens assembly according to an eighth embodiment of the disclosure;

FIG. 16 shows spherical aberration curves, astigmatic field curves and a distortion curve of the image capturing system lens assembly according to an eighth embodiment;

FIG. 17 is a schematic view of an image capturing system lens assembly according to a ninth embodiment of the disclosure; and

FIG. 18 shows spherical aberration curves, astigmatic field curves and a distortion curve of the image capturing system lens assembly according to a ninth embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An image capturing system lens assembly comprises, in order from an object side to an image side, a first lens element, a second lens element, a third lens element and a fourth lens element.

The first lens element with positive refractive power has a convex object-side surface and a convex image-side surface, so that it is favorable for providing a major portion of the positive refractive power of the image capturing system lens assembly. Also, the refraction variation of incident light can be effectively reduced and the total track length of the image capturing system lens assembly can be shortened since the distribution of the positive refractive power of the lens elements is balanced.

The second lens element with positive refractive power has a convex image-side surface so that the positive refractive power of the image capturing system lens assembly can be evenly distributed and it is favorable for reducing the sensitivity of the image capturing system lens assembly.

The third lens element with positive refractive power has a concave object-side surface and a convex image-side surface so that the distribution of the positive refractive power of the image capturing system lens assembly can be effectively balanced and the astigmatism can be corrected.

The fourth lens element with positive refractive power has a convex object-side surface and an image-side surface being concave at a paraxial region and convex away from the paraxial region so that it is favorable for reducing the spherical aberration and the sensitivity of the image capturing system lens assembly. Accordingly, the angle at which the incident light projects onto an image sensor from the off-axis field can be effectively reduced in order to improve the sensing efficiency of the image sensor to further correct the aberrations caused by the off-axis field.

When a curvature radius of the object-side surface of the first lens element is R1, and a curvature radius of the image-side surface of the first lens element is R2, the following relationship is satisfied: −0.45<(R1+R2)/(R1−R2)<0.85. Therefore, it is favorable for effectively reducing the spherical aberration, thereby enhancing the image quality. Preferably, the following relationship is satisfied: −0.25<(R1+R2)/(R1−R2)<0.75.

When a focal length of the image capturing system lens assembly is f, a focal length of the second lens element is f2, a focal length of the third lens element is f3, and the focal length of the fourth lens element is f4, the following relationship is satisfied: 0<|f/f2|+|f/f3|+|f/f4|<1.0. Therefore, it is favorable for balancing the distribution of the positive refractive power and reducing the sensitivity of the image capturing system lens assembly. Preferably, the following relationship is satisfied: 0.2<|f/f2|+|f/f3|+|f/f4|<0.8.

When the focal length of the image capturing system lens assembly is f, and the focal length of the fourth lens element is f4, the following relationship is satisfied: 0<f/f4<0.5. Therefore, it is favorable for avoiding excessive refractive power, and further reducing the system sensitivity and the aberration.

When a central thickness of the first lens element is CT1, a central thickness of the second lens element is CT2, a central thickness of the third lens element is CT3, and a central thickness of the fourth lens element is CT4, the following relationships are satisfied: CT4>CT1, CT4>CT2, and CT4>CT3. Therefore, it is favorable for manufacturing and assembling the lens elements as well as aberration corrections of the image capturing system lens assembly with a proper lens thickness of the fourth lens element. Consequently, it is favorable for enhancing the image quality.

When the focal length of the image capturing system lens assembly is f, a focal length of the first lens element is f1, the following relationship is satisfied: 0.3<f/f1<1.0. Therefore, the refractive power of the first lens element can be distributed properly so as to avoid excessive spherical aberrations.

When a curvature radius of the object-side surface of the fourth lens element is R7, and a curvature radius of the image-side surface of the fourth lens element is R8, the following relationship is satisfied: 0.9<R7/R8<1.5. Therefore, it is favorable for reducing the spherical aberration as well as the astigmatism.

When an axial distance between the second lens element and the third lens element is T23, and the focal length of the image capturing system lens assembly is f, the following relationship is satisfied: 0<T23/f<0.4. Therefore, it is favorable for assembling the lens elements in order to raise the manufacturing yield rate. Preferably, the following relationship is satisfied: 0<T23/f<0.25.

When the central thickness of the third lens element is CT3, and the focal length of the image capturing system lens assembly is f, the following relationship is satisfied: 0<CT3/f<0.25. Therefore, it is favorable for enhancing the moldability and the homogeneity of the lens elements during plastic injection molding process in order to raise the manufacturing yield rate.

The image capturing system lens assembly is also applicable to an infrared wavelength range between 780 nanometers (nm) and 950 nm, which enhances the application of special circumstances. Therefore, the image capturing system lens assembly is applicable not only to infrared photography but also to the demand for motion video capturing and recognition.

According to the image capturing system lens assembly of this disclosure, the lens elements thereof can be made of plastic material or glass. When the lens element is made of glass material, the allocation of the refractive power of the image capturing system lens assembly may be more flexible and easier to design. When the lens element is made of plastic material, the manufacturing cost can be effectively reduced. Furthermore, the surface of each lens element can be aspheric, so that it is easier to make the surface into non-spherical shapes. As a result, more controllable variables are obtained, the aberration is reduced, and the number of required lens elements can be reduced while constructing the image capturing system lens assembly. Therefore, the total track length of the image capturing system lens assembly can also be reduced.

According to the image capturing system lens assembly of the disclosure, when the lens element has a convex surface, it indicates that the paraxial region of the surface is convex; and when the lens element has a concave surface, it indicates that the paraxial region of the surface is concave.

According to the image capturing system lens assembly of the disclosure, the image capturing system lens assembly can include at least one stop, such as an aperture stop, a glare stop or a field stop. Said glare stop or said field stop is disposed to eliminate the stray light and thereby improve the image resolution thereof.

According to the image capturing system lens assembly of the disclosure, an aperture stop can be configured as a front stop or a middle stop. A front stop can provide a longer distance between an exit pupil of the image capturing system lens assembly and an image plane and which improves the image-sensing efficiency of an image sensor. A middle stop is favorable for enlarging the field of view of the image capturing system lens assembly and thereby provides a wider field of view for the same.

According to the above description of the disclosure, the following first-ninth specific embodiments are provided for further explanation.

### First Embodiment

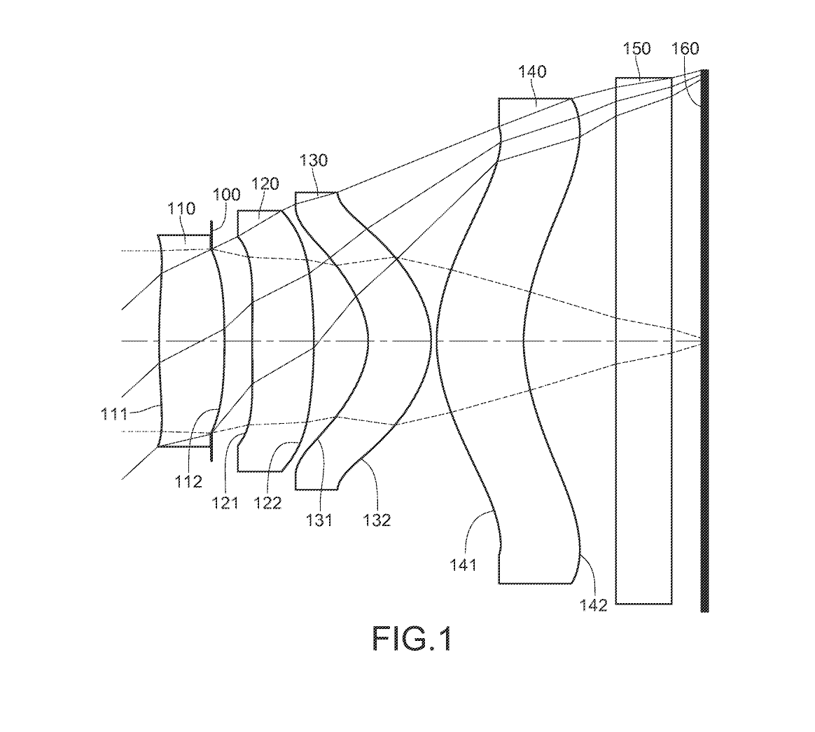

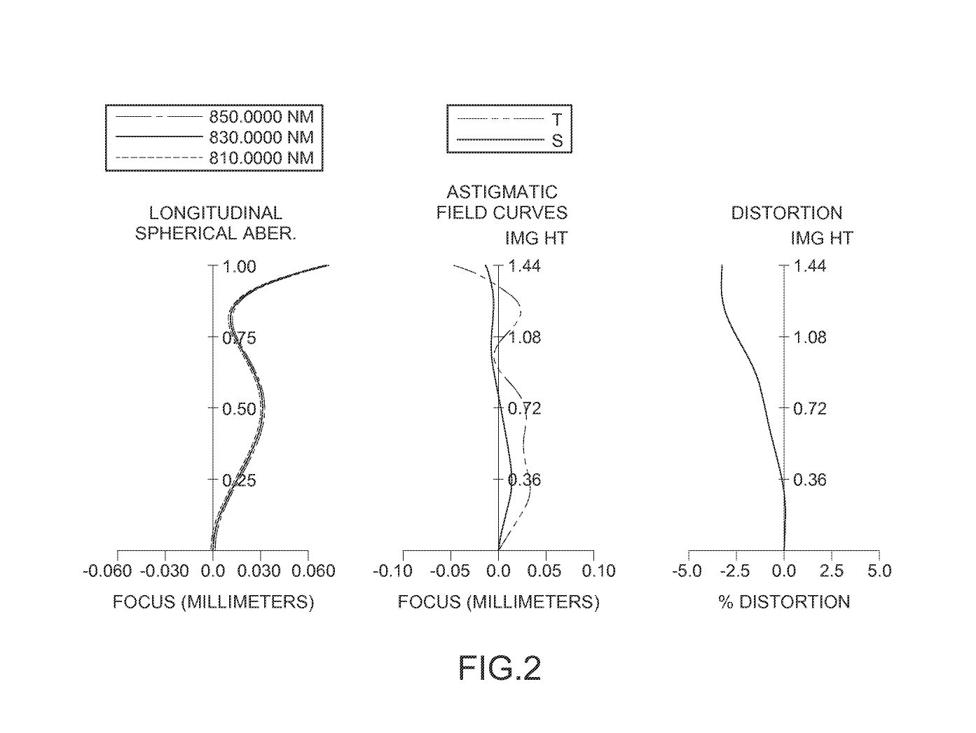

FIG. 1 is a schematic view of an image capturing system lens assembly according to the first embodiment of the disclosure. FIG. 2 shows spherical aberration curves, astigmatic field curves and a distortion curve of the image capturing system lens assembly according to the first embodiment. In FIG. 1, the image capturing system lens assembly comprises, in order from an object side to an image side, the first lens element 110, an aperture stop 100, the second lens element 120, the third lens element 130, the fourth lens element 140, the fifth lens element 150, a filter 150 and an image plane 160. The image capturing system lens assembly according to the first embodiment is applicable to an infrared wavelength range between 780 nm and 950 nm.

The first lens element 110 with positive refractive power has a convex object-side surface 111 and a convex image-side surface 112, and is made of plastic material. The object-side surface 111 and the image-side surface 112 of the first lens element 110 are aspheric.

The second lens element 120 with positive refractive power has a convex object-side surface 121 and a convex image-side surface 122, and is made of plastic material. The object-side surface 121 and the image-side surface 122 of the second lens element 120 are aspheric.

The third lens element 130 with positive refractive power has a concave object-side surface 131 and a convex image-side surface 132, and is made of plastic material. The object-side surface 131 and the image-side surface 132 of the third lens element 130 are aspheric.

The fourth lens element 140 with positive refractive power has a convex object-side surface 141 and an image-side surface 142 being concave at a paraxial region and convex away from the paraxial region, and is made of plastic material. The object-side surface 141 and the image-side surface 142 of the fourth lens element 140 are aspheric. The fourth lens element 140 has the greatest central thickness among the lens elements with refractive powers.

The filter 150 is made of glass material and located between the fourth lens element 140 and the image plane 160, and will not affect the focal length of the image capturing system lens assembly.

The equation of the aspheric surface profiles of the aforementioned lens elements of the first embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i}^{ } ( Ai ) \times ( {Y}^{i} )$$

where:

X is the relative distance between a point on the aspheric surface spaced at a distance Y from the optical axis and the tangential plane at the aspheric surface vertex;

Y is the distance from the point on the curve of the aspheric surface to the optical axis;

R is the curvature radius of the lens elements;

k is the conic coefficient; and

Ai is the i-th aspheric coefficient.

In the image capturing system lens assembly according to the first embodiment, when a focal length of the image capturing system lens assembly is f, an f-number of the image capturing system lens assembly is Fno, and a half of the maximal field of view is HFOV, these parameters have the following values: f=1.61 mm; Fno=1.65; and HFOV=42.5 degrees.

In the image capturing system lens assembly according to the first embodiment, when a curvature radius of the object-side surface 111 of the first lens element 110 is R1, and a curvature radius of an image-side surface 112 of the first lens element 110 is R2, the following relationship is satisfied: (R1+R2)/(R1-R2)=−0.07.

In the image capturing system lens assembly according to the first embodiment, when the focal length of the image capturing system lens assembly is f, and a focal length of the fourth lens element 140 is f4, the following relationship is satisfied: f/f4=0.27.

In the image capturing system lens assembly according to the first embodiment, when the focal length of the image capturing system lens assembly is f, and a focal length of the first lens element 110 is f1, the following relationship is satisfied: f/f1=0.42.

In the image capturing system lens assembly according to the first embodiment, when a curvature radius of the object-side surface 141 of the fourth lens element 140 is R7, and a curvature radius of the image-side surface 142 of the fourth lens element 140 is R8, the following relationship is satisfied: R7/R8=0.98.

In the image capturing system lens assembly according to the first embodiment, when an axial distance between the second lens element 120 and the third lens element 130 is T23, and the focal length of the image capturing system lens assembly is f, the following relationship is satisfied: T23/f=0.18.

In the image capturing system lens assembly according to the first embodiment, when a central thickness of the third lens element 130 is CT3, and the focal length of the image capturing system lens assembly is f, the following relationship is satisfied: CT3/f=0.21.

In the image capturing system lens assembly according to the first embodiment, when the focal length of the image capturing system lens assembly is f, the focal length of the second lens element 120 is f2, the focal length of the third lens element 130 is f3, and the focal length of the fourth lens element 140 is f4, the following relationship is satisfied: |f/f2|+|f/f3|+|f/f4|=0.74.

The detailed optical data of the first embodiment are shown in Table 1 and the aspheric surface data are shown in Table 2 below.

TABLE 1
(Embodiment 1)
f = 1.61 mm, Fno = 1.65, HFOV = 42.5 deg.

| | | Curvature | | | | | | Focal |
|---|---|---|---|---|---|---|---|---|
| Surface # | | Radius | | Thickness | Material | | Index | Length |
| 0 | Object | Plano | | Infinity | | | | |
| 1 | Lens 1 | 3.560 | (ASP) | 0.354 | Plastic | ARTON-D4532 | 1.507 | 3.83 |
| 2 | | −4.122 | (ASP) | −0.070 | | | | |
| 3 | Ape. Stop | Plano | | 0.220 | | | | |
| 4 | Lens 2 | 10.665 | (ASP) | 0.333 | Plastic | ARTON-D4532 | 1.507 | 4.45 |
| 5 | | −2.828 | (ASP) | 0.294 | | | | |
| 6 | Lens 3 | −0.413 | (ASP) | 0.340 | Plastic | ARTON-D4532 | 1.507 | 16.21 |
| 7 | | −0.502 | (ASP) | 0.030 | | | | |
| 8 | Lens 4 | 0.840 | (ASP) | 0.470 | Plastic | MGC EP5000 | 1.616 | 5.89 |
| 9 | | 0.860 | (ASP) | 0.500 | | | | |

| | | | | | | | |
|---|---|---|---|---|---|---|---|
| 10 | Filter | Plano | 0.300 | Glass | HOYA BSC7 | 1.510 | — |
| 11 | | Plano | 0.162 | | | | |
| 12 | Image | Plano | — | | | | |

Note:
Applicable to infrared wavelengths. Reference wavelength (d-line) is 830 nm.

TABLE 2
Aspheric Coefficients

| Surface # | 1 | 2 | 4 | 5 |
|---|---|---|---|---|
| k = | 2.6537E+01 | 1.3252E+00 | 9.0000E+01 | −8.9605E+01 |
| A4 = | −1.2200E−01 | −4.5259E−01 | −6.0828E−01 | −3.9790E−01 |
| A6 = | −2.9954E+00 | −1.8941E+00 | 1.6139E−01 | 7.2792E−01 |
| A8 = | 1.1629E+01 | 5.4917E+00 | −3.6525E+00 | −3.8840E+00 |
| A10 = | −2.3363E+01 | −7.2215E+00 | — | 3.9735E+00 |
| A12 = | 3.6800E+00 | — | — | — |

| Surface # | 6 | 7 | 8 | 9 |
|---|---|---|---|---|
| k = | −2.1481E+00 | −1.4955E+00 | −8.7591E+00 | −1.0907E+01 |
| A4 = | −6.2555E−01 | −3.6740E−01 | 6.9108E−01 | 3.1452E−01 |
| A6 = | 6.7832E+00 | 2.6850E+00 | −1.8991E+00 | −3.8836E−01 |
| A8 = | −5.1648E+01 | −1.1690E+01 | 3.1718E+00 | 8.7640E−02 |
| A10 = | 1.6310E+02 | 1.4870E+01 | −3.5761E+00 | 7.6504E−02 |
| A12 = | −2.1451E+02 | 3.8576E+00 | 2.4458E+00 | −5.1943E−02 |
| A14 = | 1.0137E+02 | −1.0235E+01 | −8.9491E−01 | 9.7717E−03 |
| A16 = | — | — | 1.2998E−01 | −5.7600E−04 |

In Table 1, the curvature radius, the thickness and the focal length are shown in millimeters (mm). Surface numbers 0-12 represent the surfaces sequentially arranged from the object-side to the image-side along the optical axis. In Table 2, k represents the conic coefficient of the equation of the aspheric surface profiles. A1-A16 represent the aspheric coefficients ranging from the 1st order to the 16th order. This information related to Table 1 and Table 2 also applies to the Tables of the remaining embodiments, and so an explanation in this regard will not be provided again.

### Second Embodiment

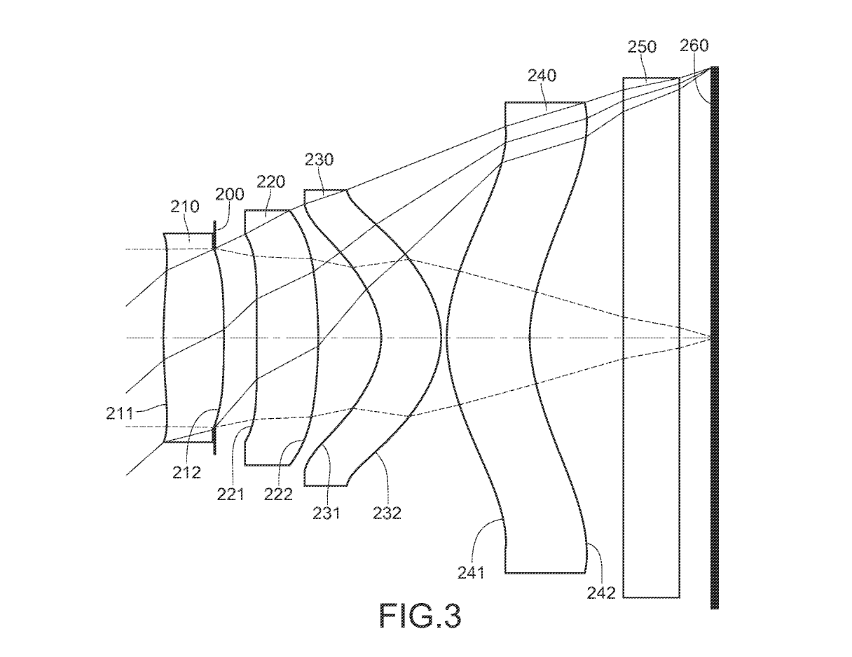

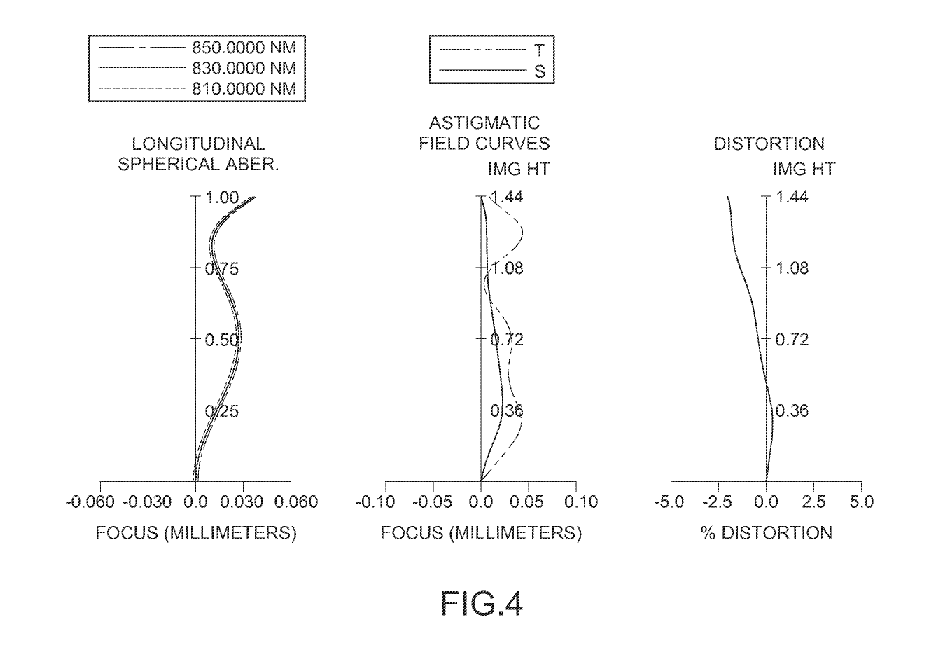

FIG. 3 is a schematic view of an image capturing system lens assembly according to the second embodiment of the disclosure. FIG. 4 shows spherical aberration curves, astigmatic field curves and a distortion curve of the image capturing system lens assembly according to the second embodiment. In FIG. 3, the image capturing system lens assembly comprises, in order from an object side to an image side, the first lens element 210, an aperture stop 200, the second lens element 220, the third lens element 230, the fourth lens element 240, a filter 250 and an image plane 260. The image capturing system lens assembly according to the second embodiment is applicable to an infrared wavelength range between 780 nm and 950 nm.

The first lens element 210 with positive refractive power has a convex object-side surface 211 and a convex image-side surface 212, and is made of plastic material. The object-side surface 211 and the image-side surface 212 of the first lens element 210 are aspheric.

The second lens element 220 with positive refractive power has a convex object-side surface 221 and a convex image-side surface 222, and is made of glass material. The object-side surface 221 and the image-side surface 222 of the second lens element 220 are aspheric.

The third lens element 230 with positive refractive power has a concave object-side surface 231 and a convex image-side surface 232, and is made of plastic material. The object-side surface 231 and the image-side surface 232 of the third lens element 230 are aspheric.

The fourth lens element 240 with positive refractive power has a convex object-side surface 241 and an image-side surface 242 being concave at a paraxial region and convex away from the paraxial region, and is made of plastic material. The object-side surface 241 and the image-side surface 242 of the fourth lens element 240 are aspheric. The fourth lens element 240 has the greatest central thickness among those of the lens elements with refractive powers.

The filter 250 is made of glass material and located between the fourth lens element 240 and the image plane 260, and will not affect the focal length of the image capturing system lens assembly.

The detailed optical data of the second embodiment are shown in Table 3 and the aspheric surface data are shown in Table 4 below.

TABLE 3
(Embodiment 2)
f = 1.65 mm, Fno = 1.75, HFOV = 41.5 deg.

| | | Curvature | | | | | | Focal |
|---|---|---|---|---|---|---|---|---|
| Surface # | | Radius | | Thickness | Material | | Index | Length |
| 0 | Object | Plano | | Infinity | | | | |
| 1 | Lens 1 | 2.976 | (ASP) | 0.322 | Plastic | ZEONEX K26R | 1.528 | 4.05 |
| 2 | | −7.317 | (ASP) | −0.048 | | | | |
| 3 | Ape. Stop | Plano | | 0.222 | | | | |
| 4 | Lens 2 | 13.208 | (ASP) | 0.329 | Glass | SUMITA | 1.579 | 3.93 |
| | | | | | | KCSK 120 | | |
| 5 | | −2.722 | (ASP) | 0.336 | | | | |
| 6 | Lens 3 | −0.408 | (ASP) | 0.320 | Plastic | PC | 1.569 | 9.76 |
| 7 | | −0.488 | (ASP) | 0.030 | | | | |
| 8 | Lens 4 | 0.829 | (ASP) | 0.442 | Plastic | MGC EP5000 | 1.616 | 9.94 |
| 9 | | 0.765 | (ASP) | 0.500 | | | | |

| | | | | | | | |
|---|---|---|---|---|---|---|---|
| 10 | Filter | Plano | 0.300 | Glass | HOYA BSC7 | 1.510 | — |
| 11 | | Plano | 0.169 | | | | |
| 12 | Image | Plano | — | | | | |

Note:
Applicable to infrared waveband. Reference wavelength (d-line) is 830 nm.

TABLE 4
Aspheric Coefficients

| Surface # | 1 | 2 | 4 | 5 |
|---|---|---|---|---|
| k = | 2.0598E+01 | 3.7593E+01 | 9.0000E+01 | −7.7820E+01 |
| A4 = | −2.1527E−01 | −5.2672E−01 | −5.0538E−01 | −4.3552E−01 |
| A6 = | −2.7601E+00 | −1.5902E+00 | −1.4356E−01 | 7.4529E−01 |
| A8 = | 1.0835E+01 | 4.7204E+00 | −3.1691E+00 | −3.6865E+00 |
| A10 = | −2.5641E+01 | −6.4710E+00 | 2.2775E+00 | 4.1239E+00 |
| A12 = | 9.4402E+00 | −2.2520E+00 | 1.3326E+00 | −5.8000E−02 |
| A14 = | −1.3724E+00 | −2.6983E+00 | −1.7890E−01 | −1.7336E−01 |
| A16 = | −9.4513E+00 | −7.0154E+00 | −1.2606E+01 | −4.0448E−01 |

| Surface # | 6 | 7 | 8 | 9 |
|---|---|---|---|---|
| k = | −2.0512E+00 | −1.4829E+00 | −9.0334E+00 | −9.1788E+00 |
| A4 = | −6.1957E−01 | −3.4825E−01 | 6.4771E−01 | 2.3477E−01 |
| A6 = | 6.7605E+00 | 2.7523E+00 | −1.8919E+00 | −3.2053E−01 |
| A8 = | −5.1739E+01 | −1.1659E+01 | 3.1825E+00 | 7.4030E−02 |
| A10 = | 1.6318E+02 | 1.4741E+01 | −3.5725E+00 | 7.3987E−02 |
| A12 = | −2.1448E+02 | 3.7919E+00 | 2.4428E+00 | −5.1824E−02 |
| A14 = | 1.0134E+02 | −1.0273E+01 | −8.9716E−01 | 1.0791E−02 |
| A16 = | −7.0795E−02 | 3.2015E−02 | 1.3168E−01 | −8.5514E−04 |

In the image capturing system lens assembly according to the second embodiment, the equation of the aspheric surface profiles of the second embodiment is the same as those stated in the first embodiment. The definitions of f, Fno, HFOV, R1, R2, R7, R8, T23, CT3, f1, f2, f3 and f4 are the same as those stated in the first embodiment with corresponding values for the second embodiment. Moreover, these parameters can be calculated from Table 3 as the following values and satisfy the following relationships:

| | | | |
|---|---|---|---|
| f (mm) | 1.65 | f/f1 | 0.41 |
| Fno | 1.75 | R7/R8 | 1.08 |
| HFOV (deg.) | 41.5 | T23/f | 0.20 |
| (R1 + R2)/(R1 − R2) | −0.42 | CT3/f | 0.19 |
| f/f4 | 0.17 | \|f/f2\| + \|f/f3\| + \|f/f4\| | 0.76 |

### Third Embodiment

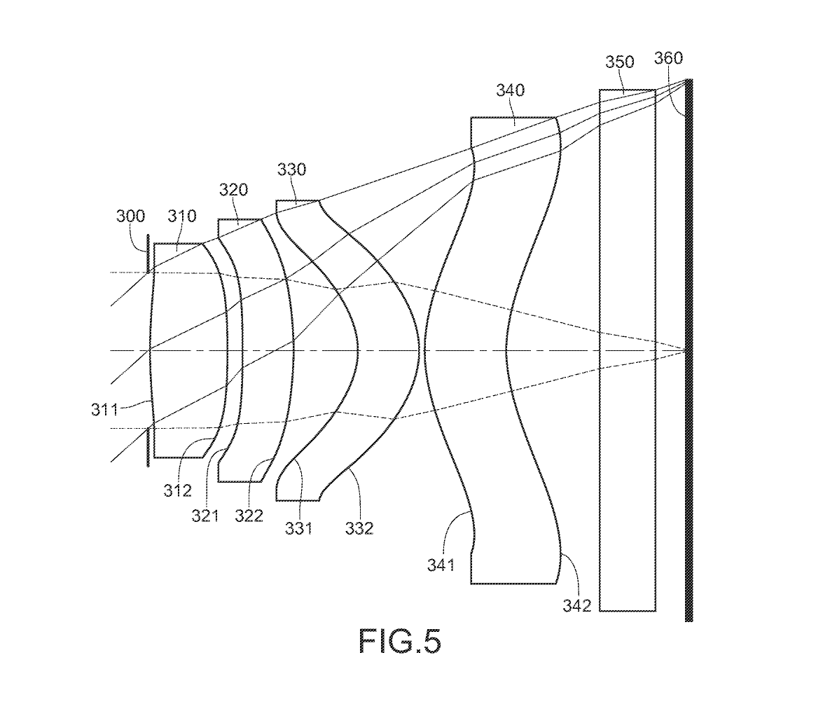

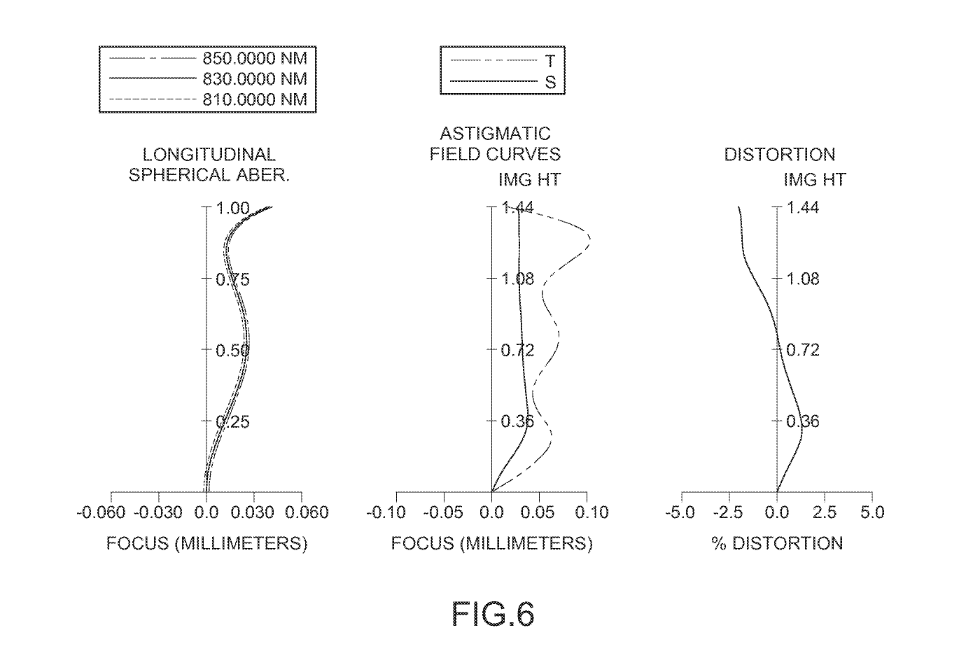

FIG. 5 is a schematic view of an image capturing system lens assembly according to the third embodiment of the disclosure. FIG. 6 shows spherical aberration curves, astigmatic field curves and a distortion curve of the image capturing system lens assembly according to the third embodiment. In FIG. 5, the image capturing system lens assembly comprises, in order from an object side to an image side, an aperture stop 300, the first lens element 310, the second lens element 320, the third lens element 330, the fourth lens element 340, a filter 350 and an image plane 360. The image capturing system lens assembly according to the third embodiment is applicable to an infrared wavelength range between 780 nm and 950 nm.

The first lens element 310 with positive refractive power has a convex object-side surface 311 and a convex image-side surface 312, and is made of plastic material. The object-side surface 311 and the image-side surface 312 of the first lens element 310 are aspheric.

The second lens element 320 with positive refractive power has a concave object-side surface 321 and a convex image-side surface 322, and is made of plastic material. The object-side surface 321 and the image-side surface 322 of the second lens element 320 are aspheric.

The third lens element 330 with positive refractive power has a concave object-side surface 331 and a convex image-side surface 332, and is made of plastic material. The object-side surface 331 and the image-side surface 332 of the third lens element 330 are aspheric.

The fourth lens element 340 with positive refractive power has a convex object-side surface 341 and an image-side surface 342 being concave at a paraxial region and convex away from the paraxial region, and is made of plastic material. The object-side surface 341 and the image-side surface 342 of the fourth lens element 340 are aspheric. The fourth lens element 340 has the greatest central thickness among the lens elements with refractive powers.

The filter 350 is made of glass material and located between the fourth lens element 340 and the image plane 360, and will not affect the focal length of the image capturing system lens assembly.

The detailed optical data of the third embodiment are shown in Table 5 and the aspheric surface data are shown in Table 6 below.

TABLE 5
(Embodiment 3)
f = 1.63 mm, Fno = 1.95, HFOV = 41.9 deg.

| | | Curvature | | | | | Abbe | Focal |
|---|---|---|---|---|---|---|---|---|
| Surface # | | Radius | | Thickness | Material | | # | Length |
| 0 | Object | Plano | | Infinity | | | | |
| 1 | Ape. Stop | Plano | | 0.010 | | | | |
| 2 | Lens 1 | 2.799 | (ASP) | 0.415 | Plastic | ZEONEX | 1.528 | 3.31 |
| | | | | | | K26R | | |
| 3 | | −4.406 | (ASP) | 0.081 | | | | |
| 4 | Lens 2 | −7.354 | (ASP) | 0.273 | Plastic | PC | 1.569 | 4.29 |
| 5 | | −1.860 | (ASP) | 0.345 | | | | |
| 6 | Lens 3 | −0.408 | (ASP) | 0.328 | Plastic | PC | 1.569 | 9.07 |
| 7 | | −0.489 | (ASP) | 0.030 | | | | |
| 8 | Lens 4 | 0.838 | (ASP) | 0.437 | Plastic | MGC EP5000 | 1.616 | 15.00 |
| 9 | | 0.738 | (ASP) | 0.500 | | | | |

| | | | | | | | |
|---|---|---|---|---|---|---|---|
| 10 | Filter | Plano | 0.300 | Glass | HOYA BSC7 | 1.510 | — |
| 11 | | Plano | 0.161 | | | | |
| 12 | Image | Plano | — | | | | |

Note:
Applicable to infrared waveband. Reference wavelength (d-line) is 830 nm.

TABLE 6
Aspheric Coefficients

| | Surface # | | | |
|---|---|---|---|---|
| | 2 | 3 | 4 | 5 |
| k = | 2.3600E+01 | 3.5186E+01 | 5.1808E+01 | −2.6577E+01 |
| A4 = | −2.0565E−01 | −5.6872E−01 | −5.1684E−01 | −4.1613E−01 |
| A6 = | −2.5191E+00 | −1.6770E+00 | −4.6845E−01 | 7.9561E−01 |
| A8 = | 1.0587E+01 | 4.5813E+00 | −3.9442E+00 | −3.6160E+00 |
| A10 = | −3.2759E+01 | −7.7863E+00 | 5.2278E+00 | 4.3956E+00 |
| A12 = | 8.4072E+00 | −2.2569E+00 | 5.8724E+00 | −2.9862E−01 |
| A14 = | −8.5008E+00 | 7.5742E+00 | 4.9444E−01 | −2.2781E−01 |
| A16 = | −5.0009E+01 | 6.3076E+01 | 3.3921E+01 | 2.2372E+00 |
| | Surface # | | | |
| | 6 | 7 | 8 | 9 |
| k = | −1.9838E+00 | −1.4347E+00 | −9.8821E+00 | −7.8477E+00 |
| A4 = | −6.7957E−01 | −3.5214E−01 | 6.8207E−01 | 2.2915E−01 |
| A6 = | 6.5253E+00 | 2.6978E+00 | −2.0469E+00 | −3.9198E−01 |
| A8 = | −5.1220E+01 | −1.1669E+01 | 3.2852E+00 | 1.4840E−01 |
| A10 = | 1.6286E+02 | 1.4767E+01 | −3.5393E+00 | 5.9592E−02 |
| A12 = | −2.1426E+02 | 3.3664E+00 | 2.4068E+00 | −6.3036E−02 |
| A14 = | 1.0166E+02 | −1.0405E+01 | −9.2009E−01 | 1.3002E−02 |
| A16 = | −3.7168E−01 | 1.0628E+00 | 1.4407E−01 | 3.8413E−06 |

In the image capturing system lens assembly according to the third embodiment, the equation of the aspheric surface profiles of the third embodiment is the same as those stated in the first embodiment. The definitions of f, Fno, HFOV, R1, R2, R7, R8, T23, CT3, f1, f2, f3 and f4 are the same as those stated in the first embodiment with corresponding values for the third embodiment. Moreover, these parameters can be calculated from Table 5 as the following values and satisfy the following relationships:

| | | | |
|---|---|---|---|
| f (mm) | 1.63 | f/f1 | 0.49 |
| Fno | 1.95 | R7/R8 | 1.13 |
| HFOV (deg.) | 41.9 | T23/f | 0.21 |
| (R1 + R2)/(R1 − R2) | −0.22 | CT3/f | 0.20 |
| f/f4 | 0.11 | \|f/f2\| + \|f/f3\| + \|f/f4\| | 0.67 |

### Fourth Embodiment

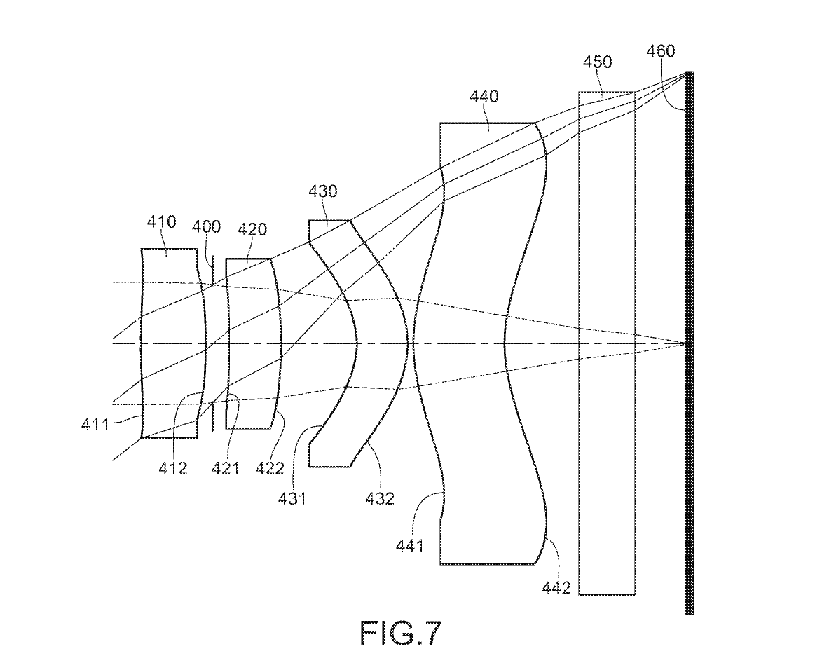

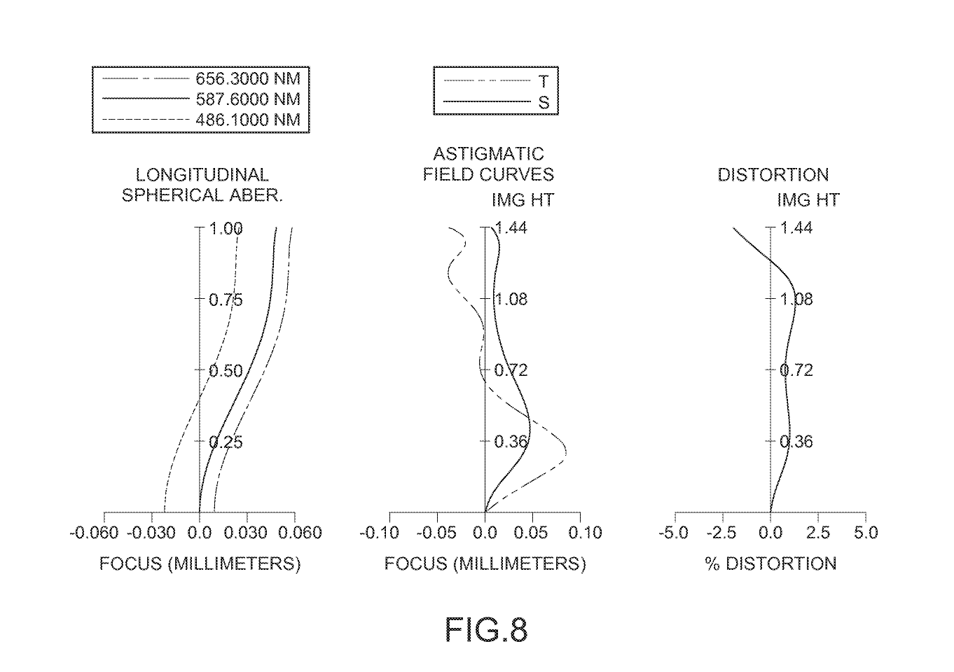

FIG. 7 is a schematic view of an image capturing system lens assembly according to the fourth embodiment of the disclosure. FIG. 8 shows spherical aberration curves, astigmatic field curves and a distortion curve of the image capturing system lens assembly according to the fourth embodiment. In FIG. 7, the image capturing system lens assembly comprises, in order from an object side to an image side, the first lens element 410, an aperture stop 400, the second lens element 420, the third lens element 430, the fourth lens element 440, an IR-cut filter 450 and an image plane 460.

The first lens element 410 with positive refractive power has a convex object-side surface 411 and a convex image-side surface 412, and is made of plastic material. The object-side surface 411 and the image-side surface 412 of the first lens element 410 are aspheric.

The second lens element 420 with positive refractive power has a concave object-side surface 421 and a convex image-side surface 422, and is made of plastic material. The object-side surface 421 and the image-side surface 422 of the second lens element 420 are aspheric.

The third lens element 430 with positive refractive power has a concave object-side surface 431 and a convex image-side surface 432, and is made of plastic material. The object-side surface 431 and the image-side surface 432 of the third lens element 430 are aspheric.

The fourth lens element 440 with positive refractive power has a convex object-side surface 441 and an image-side surface 442 being concave at a paraxial region and convex away from the paraxial region, and is made of plastic material. The object-side surface 441 and the image-side surface 442 of the fourth lens element 440 are aspheric. The fourth lens element 440 has the greatest central thickness among the lens elements with refractive powers.

The IR-cut filter 450 is made of glass material and located between the fourth lens element 440 and the image plane 460, and will not affect the focal length of the image capturing system lens assembly.

The detailed optical data of the fourth embodiment are shown in Table 7 and the aspheric surface data are shown in Table 8 below.

TABLE 7
(Embodiment 4)
f = 1.86 mm, Fno = 2.85, HFOV = 37.9 deg.

| | | Curvature | | | | | Abbe | Focal |
|---|---|---|---|---|---|---|---|---|
| Surface # | | Radius | | Thickness | Material | Index | # | Length |
| 0 | Object | Plano | | Infinity | | | | |
| 1 | Lens 1 | 3.689 | (ASP) | 0.347 | Plastic | 1.535 | 55.7 | 2.99 |
| 2 | | −2.727 | (ASP) | 0.039 | | | | |
| 3 | Ape. Stop | Plano | | 0.085 | | | | |
| 4 | Lens 2 | −10.720 | (ASP) | 0.278 | Plastic | 1.514 | 56.8 | 6.04 |
| 5 | | −2.428 | (ASP) | 0.405 | | | | |
| 6 | Lens 3 | −0.450 | (ASP) | 0.272 | Plastic | 1.514 | 56.8 | 60.97 |
| 7 | | −0.535 | (ASP) | 0.030 | | | | |
| 8 | Lens 4 | 0.846 | (ASP) | 0.487 | Plastic | 1.535 | 55.7 | 17.82 |
| 9 | | 0.739 | (ASP) | 0.400 | | | | |

| | | | | | | | |
|---|---|---|---|---|---|---|---|
| 10 | IR-Cut | Plano | 0.300 | Glass | 1.517 | 64.2 | — |
| | Filter | | | | | | |
| 11 | | Plano | 0.272 | | | | |
| 12 | Image | Plano | — | | | | |

Note:
Reference wavelength (d-line) is 587.6 nm.

TABLE 8
Aspheric Coefficients

| | Surface # | | | |
|---|---|---|---|---|
| | 1 | 2 | 4 | 5 |
| k = | 2.4564E+01 | 4.5308E+00 | −5.6728E+01 | −3.9977E+01 |
| A4 = | −1.7306E−01 | −4.6098E−01 | −4.6978E−01 | −4.9990E−01 |
| A6 = | −3.1506E+00 | −1.7249E+00 | 2.4252E−01 | 3.8805E−01 |
| A8 = | 1.1536E+01 | 6.1459E+00 | −5.8262E+00 | −4.5808E+00 |
| A10 = | −2.3834E+01 | −6.4972E+00 | 1.3981E+00 | 3.0945E+00 |
| A12 = | 7.0892E+00 | −1.1106E+00 | 3.4168E−01 | 3.6999E−07 |
| A14 = | −6.1428E−01 | −1.3515E+01 | 1.1300E+01 | 3.2879E−07 |
| A16 = | −3.2170E−01 | −2.4256E+01 | −1.9310E+02 | 2.9230E−07 |
| | Surface # | | | |
| | 6 | 7 | 8 | 9 |
| k = | −2.3408E+00 | −1.7095E+00 | −1.3356E+01 | −8.8402E+00 |
| A4 = | −5.3968E−01 | −2.1656E−01 | 5.3262E−01 | 1.2878E−01 |
| A6 = | 6.9044E+00 | 2.9378E+00 | −1.9033E+00 | −2.4558E−01 |
| A8 = | −5.1494E+01 | −1.1423E+01 | 3.1431E+00 | 3.4489E−02 |
| A10 = | 1.6346E+02 | 1.5140E+01 | −3.5719E+00 | 6.8709E−02 |
| A12 = | −2.1406E+02 | 4.1357E+00 | 2.4488E+00 | −4.9019E−02 |
| A14 = | 9.8692E+01 | −1.0225E+01 | −8.9137E−01 | 1.1037E−02 |
| A16 = | 2.9228E−07 | 4.2642E−02 | 1.4198E−01 | −6.5071E−04 |

In the image capturing system lens assembly according to the fourth embodiment, the equation of the aspheric surface profiles of the fourth embodiment is the same as those stated in the first embodiment. The definitions of f, Fno, HFOV, R1, R2, R7, R8, T23, CT3, f1, f2, f3 and f4 are the same as those stated in the first embodiment with corresponding values for the fourth embodiment. Moreover, these parameters can be calculated from Table 7 as the following values and satisfy the following relationships:

| | | | |
|---|---|---|---|
| f (mm) | 1.86 | f/f1 | 0.62 |
| Fno | 2.85 | R7/R8 | 1.14 |
| HFOV (deg.) | 37.9 | T23/f | 0.22 |
| (R1 + R2)/(R1 − R2) | 0.15 | CT3/f | 0.15 |
| f/f4 | 0.10 | \|f/f2\| + \|f/f3\| + \|f/f4\| | 0.44 |

### Fifth Embodiment

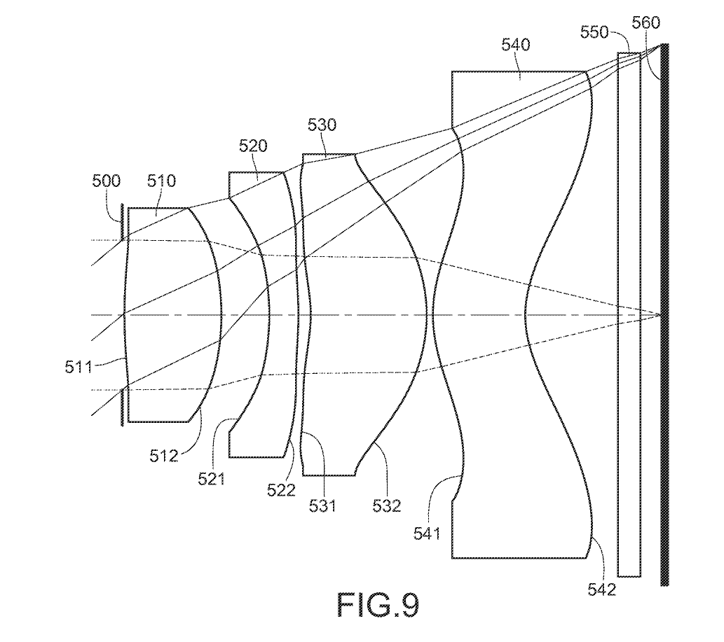

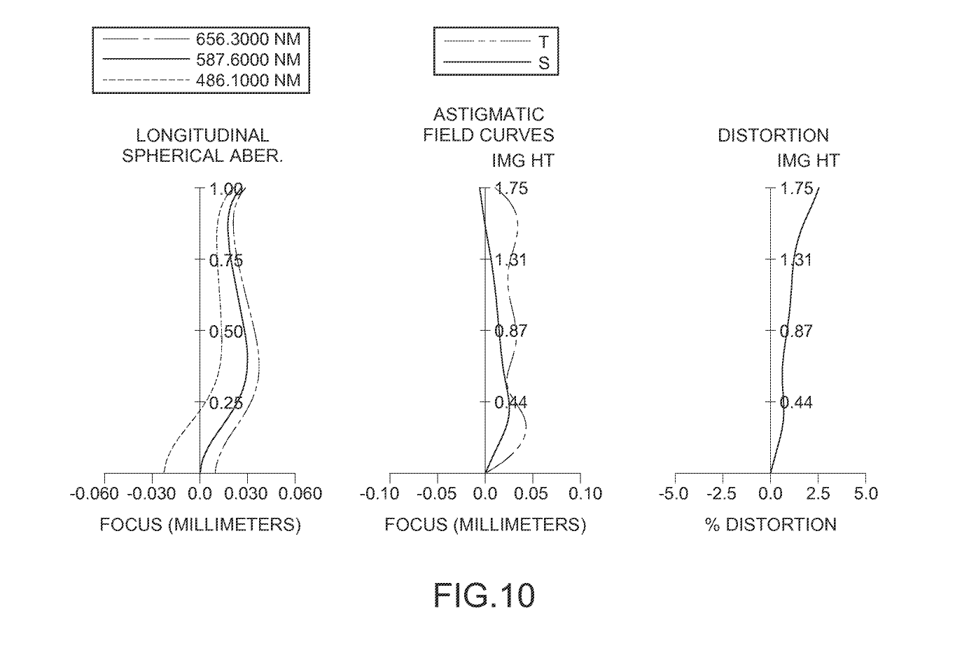

FIG. 9 is a schematic view of an image capturing system lens assembly according to the fifth embodiment of the disclosure. FIG. 10 shows spherical aberration curves, astigmatic field curves and a distortion curve of the image capturing system lens assembly according to the fifth embodiment. In FIG. 9, the image capturing system lens assembly includes, in order from an object side to an image side, an aperture stop 500, the first lens element 510, the second lens element 520, the third lens element 530, the fourth lens element 540, an IR-cut filter 550 and an image plane 560.

The first lens element 510 with positive refractive power has a convex object-side surface 511 and a convex image-side surface 512, and is made of plastic material. The object-side surface 511 and the image-side surface 512 of the first lens element 510 are aspheric.

The second lens element 520 with positive refractive power has a concave object-side surface 521 and a convex image-side surface 522, and is made of plastic material. The object-side surface 521 and the image-side surface 522 of the second lens element 520 are aspheric.

The third lens element 530 with positive refractive power has a concave object-side surface 531 and a convex image-side surface 532, and is made of plastic material. The object-side surface 531 and the image-side surface 532 of the third lens element 530 are aspheric.

The fourth lens element 540 with positive refractive power has a convex object-side surface 541 and an image-side surface 542 being concave at a paraxial region and convex away from the paraxial region, and is made of plastic material. The object-side surface 541 and the image-side surface 542 of the fourth lens element 540 are aspheric.

The IR-cut filter 550 is made of glass material and located between the fourth lens element 540 and the image plane 560, and will not affect the focal length of the image capturing system lens assembly.

The detailed optical data of the fifth embodiment are shown in Table 9 and the aspheric surface data are shown in Table 10 below.

TABLE 9
(Embodiment 5)
f = 2.04 mm, Fno = 2.10, HFOV = 39.8 deg.

| | | Curvature | | | | | Abbe | Focal |
|---|---|---|---|---|---|---|---|---|
| Surface # | | Radius | | Thickness | Material | Index | # | Length |
| 0 | Object | Plano | | Infinity | | | | |
| 1 | Ape. Stop | Plano | | 0.013 | | | | |
| 2 | Lens 1 | 3.149 | (ASP) | 0.628 | Plastic | 1.535 | 55.7 | 2.11 |
| 3 | | −1.639 | (ASP) | 0.310 | | | | |
| 4 | Lens 2 | −1.571 | (ASP) | 0.189 | Plastic | 1.634 | 23.8 | 52.67 |
| 5 | | −1.571 | (ASP) | 0.080 | | | | |
| 6 | Lens 3 | −0.811 | (ASP) | 0.750 | Plastic | 1.514 | 56.8 | 39.51 |
| 7 | | −1.024 | (ASP) | 0.040 | | | | |
| 8 | Lens 4 | 0.880 | (ASP) | 0.598 | Plastic | 1.535 | 55.7 | 74.24 |
| 9 | | 0.687 | (ASP) | 0.600 | | | | |

| | | | | | | | |
|---|---|---|---|---|---|---|---|
| 10 | IR-Cut | Plano | 0.145 | Glass | 1.517 | 64.2 | — |
| | Filter | | | | | | |
| 11 | | Plano | 0.137 | | | | |
| 12 | Image | Plano | — | | | | |

Note:
Reference wavelength (d-line) is 587.6 nm.

TABLE 10
Aspheric Coefficients

| | Surface # | | | |
|---|---|---|---|---|
| | 2 | 3 | 4 | 5 |
| k = | −2.0175E+01 | −7.6761E−01 | −3.2142E+01 | −1.0825E+02 |
| A4 = | −6.2702E−02 | −1.8361E−01 | −7.3178E−01 | 7.1358E−01 |
| A6 = | −3.7097E−01 | −3.7524E−01 | 3.7207E−01 | −2.0614E+00 |
| A8 = | 1.9180E−01 | 3.3518E−01 | −2.1419E+00 | 1.5884E+00 |
| A10 = | 1.1299E−02 | 9.6582E−01 | 8.1604E+00 | 2.9653E−02 |
| A12 = | −2.5319E+00 | −1.8479E+00 | −7.2924E+00 | −2.0260E−01 |
| A14 = | −5.4179E−08 | −2.5392E−01 | −5.8975E−01 | 1.1441E−01 |
| A16 = | −2.4681E−08 | −6.7815E−01 | 2.4253E−01 | −2.7249E−01 |
| | Surface # | | | |
| | 6 | 7 | 8 | 9 |
| k = | −2.0059E+01 | −4.0500E−01 | −5.2836E+00 | −2.7174E+00 |
| A4 = | 7.8703E−01 | 1.9495E−02 | 6.3875E−02 | −9.8689E−02 |
| A6 = | −9.3233E−01 | −8.5435E−02 | −6.2846E−01 | −5.5346E−02 |
| A8 = | −1.5074E+00 | 3.1074E−01 | 9.4487E−01 | 1.1808E−01 |
| A10 = | 3.5637E+00 | −1.5586E−01 | −8.1562E−01 | −9.2674E−02 |
| A12 = | −1.8600E+00 | 1.8896E−02 | 3.9778E−01 | 3.9609E−02 |
| A14 = | −8.7887E−02 | −2.9372E−03 | −8.9201E−02 | −9.0319E−03 |
| A16 = | 1.8258E−01 | 2.8287E−02 | 2.7906E−03 | 8.3901E−04 |

In the image capturing system lens assembly according to the fifth embodiment, the equation of the aspheric surface profiles of the fifth embodiment is the same as those stated in the first embodiment. The definitions of f, Fno, HFOV, R1, R2, R7, R8, T23, CT3, f1, f2, f3 and f4 are the same as those stated in the first embodiment with corresponding values for the fifth embodiment. Moreover, these parameters can be calculated from Table 9 as the following values and satisfy the following relationships:

| | | | |
|---|---|---|---|
| f (mm) | 2.04 | f/f1 | 0.97 |
| Fno | 2.10 | R7/R8 | 1.28 |
| HFOV (deg.) | 39.8 | T23/f | 0.04 |
| (R1 + R2)/(R1 − R2) | 0.32 | CT3/f | 0.37 |
| f/f4 | 0.03 | \|f/f2\| + \|f/f3\| + \|f/f4\| | 0.12 |

### Sixth Embodiment

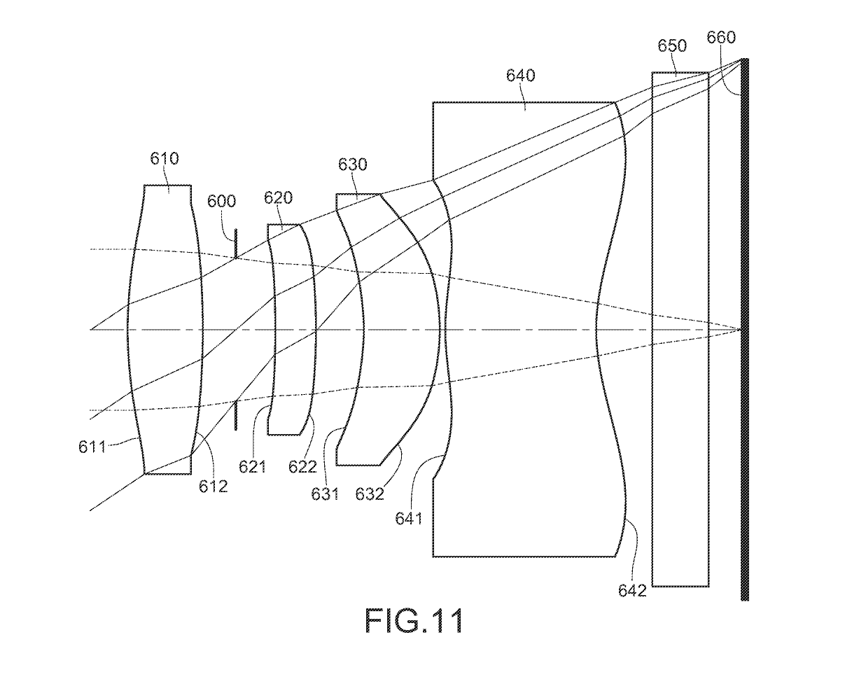

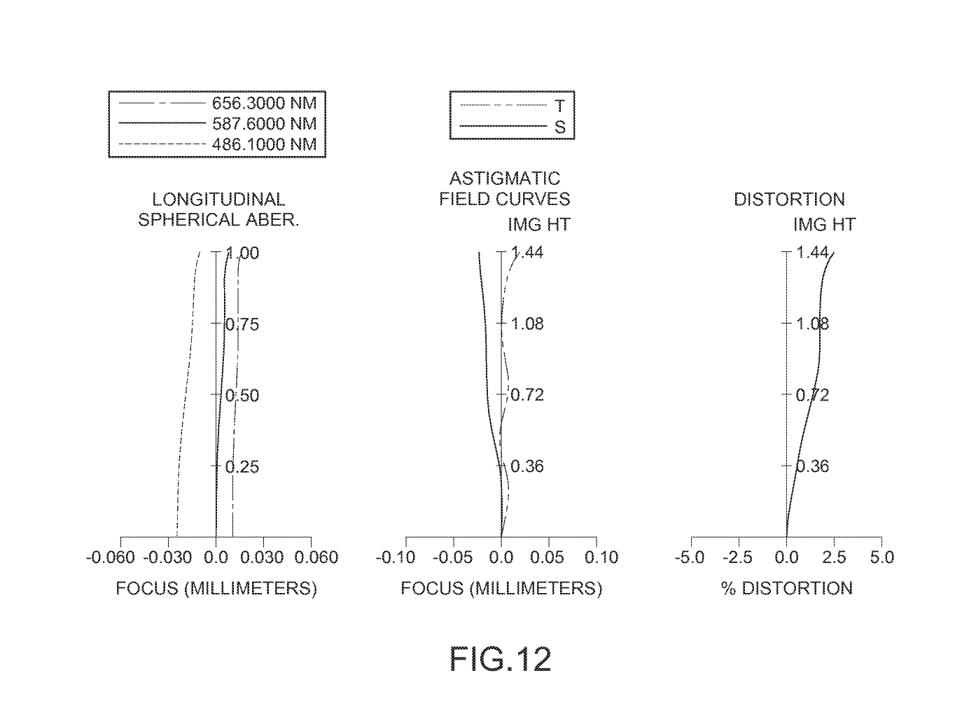

FIG. 11 is a schematic view of an image capturing system lens assembly according to the sixth embodiment of the disclosure. FIG. 12 shows spherical aberration curves, astigmatic field curves and a distortion curve of the image capturing system lens assembly according to the sixth embodiment. In FIG. 11, the image capturing system lens assembly comprises, in order from an object side to an image side, the first lens element 610, an aperture stop 600, the second lens element 620, the third lens element 630, the fourth lens element 640, an IR-cut filter 650 and an image plane 660.

The first lens element 610 with positive refractive power has a convex object-side surface 611 and a convex image-side surface 612, and is made of plastic material. The object-side surface 611 and the image-side surface 612 of the first lens element 610 are aspheric.

The second lens element 620 with positive refractive power has a concave object-side surface 621 and a convex image-side surface 622, and is made of plastic material. The object-side surface 621 and the image-side surface 622 of the second lens element 620 are aspheric.

The third lens element 630 with positive refractive power has a concave object-side surface 631 and a convex image-side surface 632, and is made of plastic material. The object-side surface 631 and the image-side surface 632 of the third lens element 630 are aspheric.

The fourth lens element 640 with positive refractive power has a convex object-side surface 641 and an image-side surface 642 being concave at a paraxial region and convex away from the paraxial region, and is made of plastic material. The object-side surface 641 and the image-side surface 642 of the fourth lens element 640 are aspheric. The fourth lens element 640 has the greatest central thickness among the lens elements with refractive powers.

The IR-cut filter 650 is made of glass material and located between the fourth lens element 640 and the image plane 660, and will not affect the focal length of the image capturing system lens assembly.

The detailed optical data of the sixth embodiment are shown in Table 11 and the aspheric surface data are shown in Table 12 below.

TABLE 11
(Embodiment 6)
f = 2.09 mm, Fno = 2.43, HFOV = 34.0 deg.

| | | Curvature | | | | | Abbe | Focal |
|---|---|---|---|---|---|---|---|---|
| Surface # | | Radius | | Thickness | Material | Index | # | Length |
| 0 | Object | Plano | | Infinity | | | | |
| 1 | Lens 1 | 2.284 | (ASP) | 0.401 | Plastic | 1.514 | 56.8 | 3.02 |
| 2 | | −4.533 | (ASP) | 0.177 | | | | |
| 3 | Ape. Stop | Plano | | 0.210 | | | | |
| 4 | Lens 2 | −5.302 | (ASP) | 0.217 | Plastic | 1.535 | 55.7 | 14.01 |
| 5 | | −3.149 | (ASP) | 0.255 | | | | |
| 6 | Lens 3 | −1.145 | (ASP) | 0.405 | Plastic | 1.535 | 55.7 | 104.41 |
| 7 | | −1.261 | (ASP) | 0.030 | | | | |
| 8 | Lens 4 | 1.277 | (ASP) | 0.805 | Plastic | 1.634 | 23.8 | 19.07 |
| 9 | | 1.079 | (ASP) | 0.300 | | | | |

| | | | | | | | |
|---|---|---|---|---|---|---|---|
| 10 | IR-Cut | Plano | 0.300 | Glass | 1.517 | 64.2 | — |
| | Filter | | | | | | |
| 11 | | Plano | 0.176 | | | | |
| 12 | Image | Plano | — | | | | |

Note:
Reference wavelength (d-line) is 587.6 nm.

TABLE 12
Aspheric Coefficients

| | Surface # | | | |
|---|---|---|---|---|
| | 1 | 2 | 4 | 5 |
| k = | 6.1775E+00 | −9.5368E+01 | −1.5000E+02 | −1.4978E+02 |
| A4 = | −1.0129E−01 | −1.1456E−01 | −1.0502E−01 | −2.2499E−01 |
| A6 = | −2.7499E−01 | 1.2128E−01 | −1.0074E+00 | −4.6503E−01 |
| A8 = | 8.0479E−01 | −6.5214E−01 | 1.7404E+00 | −1.1452E+00 |
| A10 = | −2.2279E+00 | 8.1839E−01 | −1.5388E+01 | −3.3910E+00 |
| A12 = | 2.0035E+00 | −7.4816E−01 | 1.1667E+00 | −7.2456E−03 |
| A14 = | −5.9588E−01 | 1.0536E−01 | −6.9381E−02 | −9.4417E−03 |
| A16 = | −4.3926E−01 | 1.2734E+00 | −6.7237E+00 | 1.7532E−04 |
| | Surface # | | | |
| | 6 | 7 | 8 | 9 |
| k = | −2.6520E+01 | 2.0943E−01 | −2.2285E+01 | −1.9907E+00 |
| A4 = | −4.8787E−01 | −8.5093E−01 | −4.5082E−01 | −4.0630E−01 |
| A6 = | 1.9008E+00 | 1.7508E+00 | −5.0351E−01 | 2.5505E−01 |
| A8 = | −1.0760E+01 | −2.9157E+00 | 1.3224E+00 | −9.5961E−02 |
| A10 = | 2.3007E+01 | 1.6033E+00 | −7.8008E−01 | 2.9291E−03 |
| A12 = | −1.6785E+01 | 2.6135E+00 | −2.8258E−01 | 5.9607E−03 |
| A14 = | 5.8197E+00 | 1.8101E−02 | 6.1037E−01 | −2.3065E−04 |
| A16 = | 1.7285E−02 | 1.3879E−03 | −6.5741E−01 | −2.8366E−04 |

In the image capturing system lens assembly according to the sixth embodiment, the equation of the aspheric surface profiles of the sixth embodiment is the same as those stated in the first embodiment. The definitions of f, Fno, HFOV, R1, R2, R7, R8, T23, CT3, f1, f2, f3 and f4 are the same as those stated in the first embodiment with corresponding values for the sixth embodiment. Moreover, these parameters can be calculated from Table 11 as the following values and satisfy the following relationships:

| | | | |
|---|---|---|---|
| f (mm) | 2.09 | f/f1 | 0.69 |
| Fno | 2.43 | R7/R8 | 1.18 |
| HFOV (deg.) | 34.0 | T23/f | 0.12 |
| (R1 + R2)/(R1 − R2) | −0.33 | CT3/f | 0.19 |
| f/f4 | 0.11 | \|f/f2\| + \|f/f3\| + \|f/f4\| | 0.28 |

### Seventh Embodiment

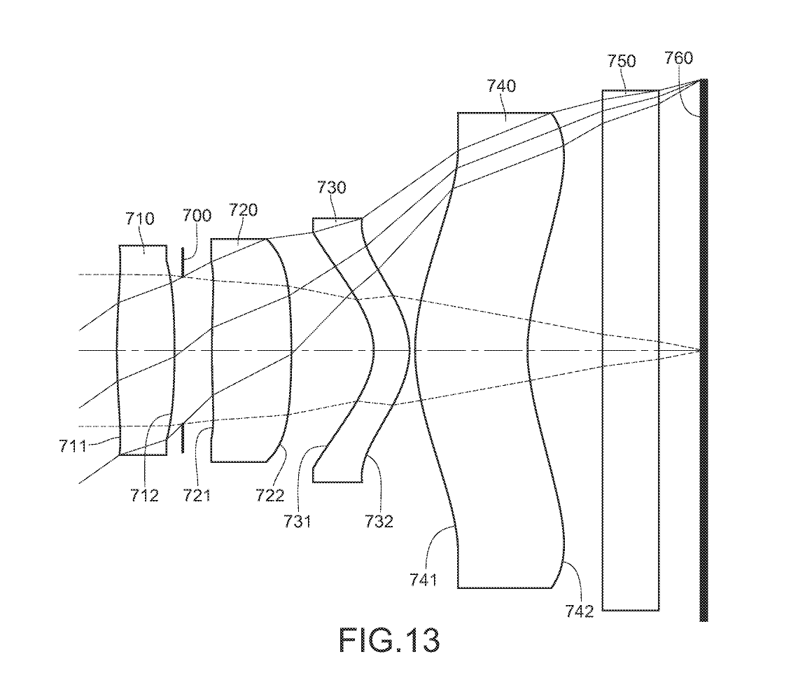

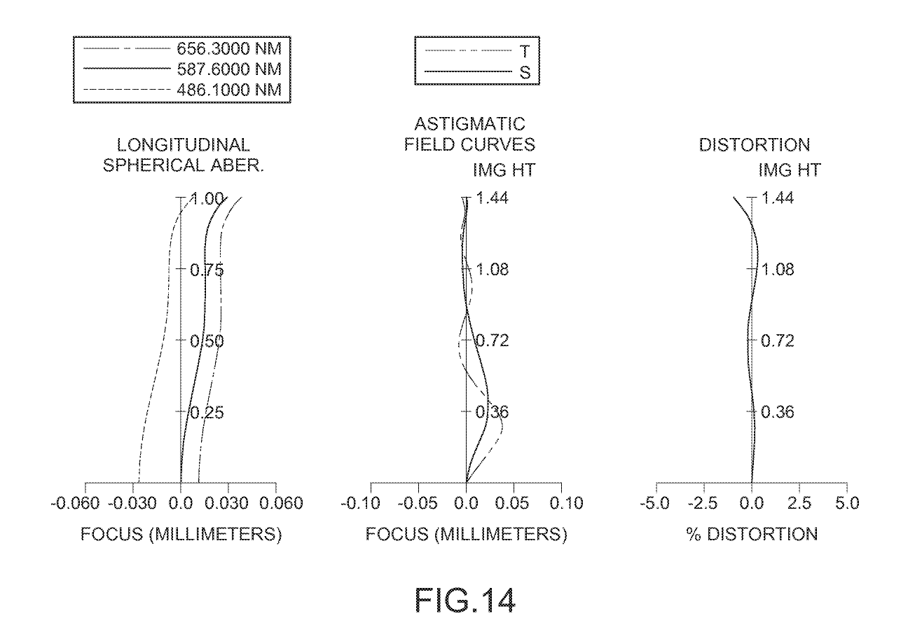

FIG. 13 is a schematic view of an image capturing system lens assembly according to the seventh embodiment of the disclosure. FIG. 14 shows spherical aberration curves, astigmatic field curves and a distortion curve of the image capturing system lens assembly according to the seventh embodiment. In FIG. 13, the image capturing system lens assembly comprises, in order from an object side to an image side, the first lens element 710, an aperture stop 700, the second lens element 720, the third lens element 730, the fourth lens element 740, an IR-cut filter 750 and an image plane 760.

The first lens element 710 with positive refractive power has a convex object-side surface 711 and a convex image-side surface 712, and is made of plastic material. The object-side surface 711 and the image-side surface 712 of the first lens element 710 are aspheric.

The second lens element 720 with positive refractive power has a convex object-side surface 721 and a convex image-side surface 722, and is made of plastic material. The object-side surface 721 and the image-side surface 722 of the second lens element 720 are aspheric.

The third lens element 730 with positive refractive power has a concave object-side surface 731 and a convex image-side surface 732, and is made of plastic material. The object-side surface 731 and the image-side surface 732 of the third lens element 730 are aspheric.

The fourth lens element 740 with positive refractive power has a convex object-side surface 741 and an image-side surface 742 being concave at a paraxial region and convex away from the paraxial region, and is made of plastic material. The object-side surface 741 and the image-side surface 742 of the fourth lens element 740 are aspheric. The fourth lens element 740 has the greatest central thickness among the lens elements with refractive powers.

The IR-cut filter 750 is made of glass material and located between the fourth lens element 740 and the image plane 760, and will not affect the focal length of the image capturing system lens assembly.

The detailed optical data of the seventh embodiment are shown in Table 13 and the aspheric surface data are shown in Table 14 below.

TABLE 13
(Embodiment 7)
f = 2.05 mm, Fno = 2.53, HFOV = 35.3 deg.

| | | Curvature | | | | | Abbe | Focal |
|---|---|---|---|---|---|---|---|---|
| Surface # | | Radius | | Thickness | Material | Index | # | Length |
| 0 | Object | Plano | | Infinity | | | | |
| 1 | Lens 1 | 3.536 | (ASP) | 0.307 | Plastic | 1.544 | 55.9 | 3.75 |
| 2 | | −4.677 | (ASP) | 0.044 | | | | |
| 3 | Ape. Stop | Plano | | 0.155 | | | | |
| 4 | Lens 2 | 5.204 | (ASP) | 0.423 | Plastic | 1.544 | 55.9 | 4.65 |
| 5 | | −4.787 | (ASP) | 0.439 | | | | |
| 6 | Lens 3 | −0.350 | (ASP) | 0.190 | Plastic | 1.634 | 23.8 | 67.99 |
| 7 | | −0.420 | (ASP) | 0.030 | | | | |
| 8 | Lens 4 | 1.033 | (ASP) | 0.598 | Plastic | 1.535 | 55.7 | 68.57 |
| 9 | | 0.849 | (ASP) | 0.400 | | | | |

| | | | | | | | |
|---|---|---|---|---|---|---|---|
| 10 | IR-Cut | Plano | 0.300 | Glass | 1.517 | 64.2 | — |
| | Filter | | | | | | |
| 11 | | Plano | 0.222 | | | | |
| 12 | Image | Plano | — | | | | |

Note:
Reference wavelength (d-line) is 587.6 nm.

TABLE 14
Aspheric Coefficients

| | Surface # | | | |
|---|---|---|---|---|
| | 1 | 2 | 4 | 5 |
| k = | 1.6943E+01 | −9.1850E+00 | 5.0434E+01 | −3.2331E+01 |
| A4 = | −1.9213E−01 | −2.4122E−01 | −2.9253E−01 | −3.4148E−01 |
| A6 = | −9.2881E−01 | −6.6316E−01 | −1.2233E−01 | −6.4632E−01 |
| A8 = | 2.7589E+00 | 1.2384E+00 | −2.7583E+00 | −2.2960E+00 |
| A10 = | −5.7538E+00 | −3.3254E+00 | −9.1201E+00 | 1.1025E+00 |
| A12 = | −5.4222E−01 | −1.2627E−01 | −2.4336E−01 | −9.5138E−02 |
| A14 = | 1.5325E−01 | −1.4737E+00 | 9.0021E−01 | 4.0397E−04 |
| A16 = | 3.8151E+00 | −1.2866E+00 | −1.0284E+01 | 1.8205E−03 |
| | Surface # | | | |
| | 6 | 7 | 8 | 9 |
| k = | −2.2259E+00 | −2.1237E+00 | −9.4244E+00 | −1.4123E+01 |
| A4 = | −1.3148E−01 | 8.4398E−02 | 1.8052E−01 | 5.8453E−02 |
| A6 = | 2.8263E+00 | 1.5586E+00 | −5.5929E−01 | −1.1964E−01 |
| A8 = | −1.2870E+01 | −2.4200E+00 | 7.5894E−01 | 4.1974E−02 |
| A10 = | 2.8589E+01 | 2.8758E+00 | −6.1573E−01 | 4.0733E−03 |
| A12 = | −2.6354E+01 | 2.7154E−01 | 2.8337E−01 | −1.0277E−02 |
| A14 = | 7.7953E+00 | −1.7374E+00 | −8.0192E−02 | −2.8412E−04 |
| A16 = | 8.6063E−02 | −1.3712E+00 | 1.3661E−02 | 9.1230E−04 |

In the image capturing system lens assembly according to the seventh embodiment, the equation of the aspheric surface profiles of the seventh embodiment is the same as those stated in the first embodiment. The definitions of f, Fno, HFOV, R1, R2, R7, R8, T23, CT3, f1, f2, f3 and f4 are the same as those stated in the first embodiment with corresponding values for the seventh embodiment. Moreover, these parameters can be calculated from Table 13 as the following values and satisfy the following relationships:

| | | | |
|---|---|---|---|
| f (mm) | 2.05 | f/f1 | 0.55 |
| Fno | 2.53 | R7/R8 | 1.22 |
| HFOV (deg.) | 35.3 | T23/f | 0.21 |
| (R1 + R2)/(R1 − R2) | −0.14 | CT3/f | 0.09 |
| f/f4 | 0.03 | \|f/f2\| + \|f/f3\| + \|f/f4\| | 0.50 |

### Eighth Embodiment

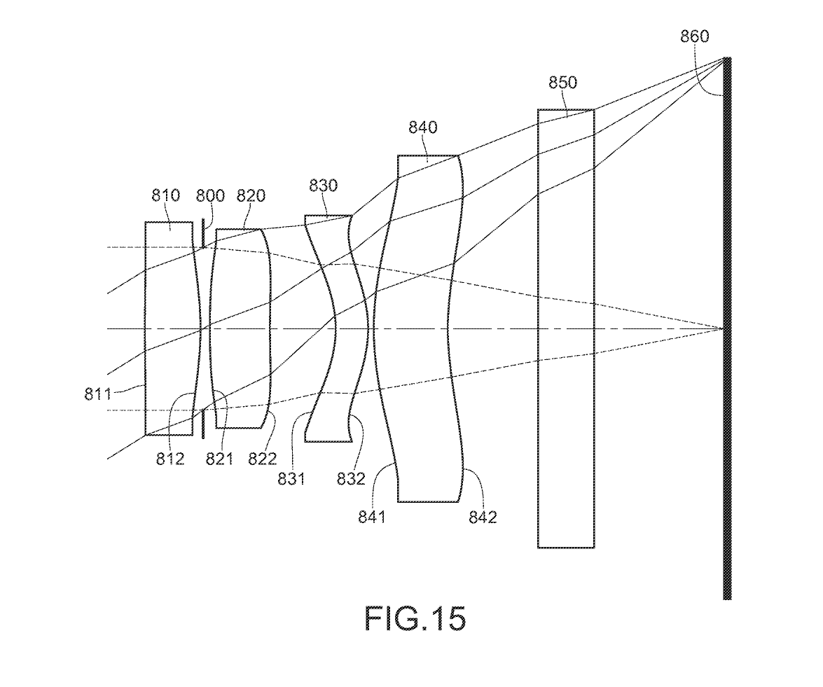

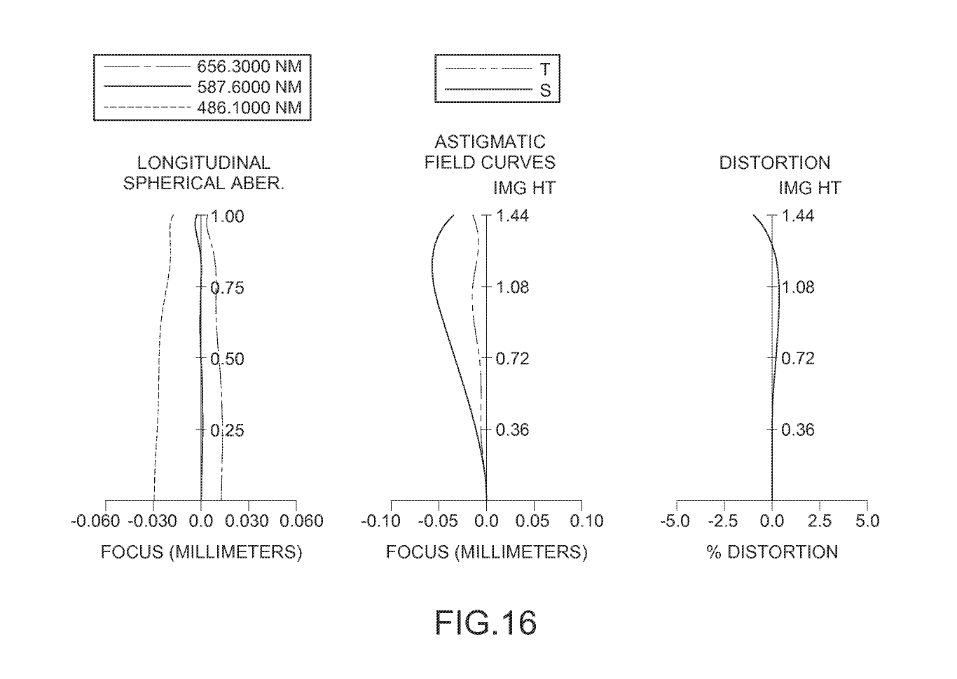

FIG. 15 is a schematic view of an image capturing system lens assembly according to the eighth embodiment of the disclosure. FIG. 16 shows spherical aberration curves, astigmatic field curves and a distortion curve of the image capturing system lens assembly according to the eighth embodiment. In FIG. 15, the image capturing system lens assembly comprises, in order from an object side to an image side, the first lens element 810, an aperture stop 800, the second lens element 820, the third lens element 830, the fourth lens element 840, an IR-cut filter 850 and an image plane 860.

The first lens element 810 with positive refractive power has a convex object-side surface 811 and a convex image-side surface 812, and is made of plastic material. The object-side surface 811 and the image-side surface 812 of the first lens element 810 are aspheric.

The second lens element 820 with positive refractive power has a convex object-side surface 821 and a concave image-side surface 822, and is made of plastic material. The object-side surface 821 and the image-side surface 822 of the second lens element 820 are aspheric.

The third lens element 830 with positive refractive power has a concave object-side surface 831 and a convex image-side surface 832, and is made of plastic material. The object-side surface 831 and the image-side surface 832 of the third lens element 830 are aspheric.

The fourth lens element 840 with positive refractive power has a convex object-side surface 841 and an image-side surface 842 being concave at a paraxial region and convex away from the paraxial region, and is made of plastic material. The object-side surface 841 and the image-side surface 842 of the fourth lens element 840 are aspheric. The fourth lens element 840 has the greatest central thickness among the lens elements with refractive powers.

The IR-cut filter 850 is made of glass material and located between the fourth lens element 840 and the image plane 860, and will not affect the focal length of the image capturing system lens assembly.

The detailed optical data of the eighth embodiment are shown in Table 15 and the aspheric surface data are shown in Table 16 below.

TABLE 15
(Embodiment 8)
f = 2.34 mm, Fno = 2.67, HFOV = 32.0 deg.

| | | Curvature | | | | | Abbe | Focal |
|---|---|---|---|---|---|---|---|---|
| Surface # | | Radius | | Thickness | Material | Index | # | Length |
| 0 | Object | Plano | | Infinity | | | | |
| 1 | Lens 1 | 8.569 | (ASP) | 0.298 | Plastic | 1.544 | 55.9 | 2.71 |
| 2 | | −1.757 | (ASP) | 0.015 | | | | |
| 3 | Ape. Stop | Plano | | 0.035 | | | | |
| 4 | Lens 2 | 4.678 | (ASP) | 0.322 | Plastic | 1.544 | 55.9 | 85.18 |
| 5 | | 5.077 | (ASP) | 0.352 | | | | |
| 6 | Lens 3 | −0.636 | (ASP) | 0.174 | Plastic | 1.634 | 23.8 | 22.38 |
| 7 | | −0.673 | (ASP) | 0.030 | | | | |
| 8 | Lens 4 | 1.585 | (ASP) | 0.397 | Plastic | 1.535 | 55.7 | 73.43 |
| 9 | | 1.508 | (ASP) | 0.483 | | | | |

| | | | | | | | |
|---|---|---|---|---|---|---|---|
| 10 | IR-Cut | Plano | 0.300 | Glass | 1.517 | 64.2 | — |
| | Filter | | | | | | |
| 11 | | Plano | 0.696 | | | | |
| 12 | Image | Plano | — | | | | |

Note:
Reference wavelength (d-line) is 587.6 nm.

TABLE 16
Aspheric Coefficients

| | Surface # | | | |
|---|---|---|---|---|
| | 1 | 2 | 4 | 5 |
| k = | −1.5000E+02 | −1.5206E+01 | 3.6424E+01 | −6.8244E+00 |
| A4 = | −2.7025E−01 | 8.8417E−02 | 3.6384E−01 | −7.6967E−01 |
| A6 = | 1.5367E−01 | 2.9975E−01 | −1.6994E−01 | −2.2818E−01 |
| A8 = | 2.3306E+00 | 2.0058E+00 | −4.1598E+00 | −4.0814E−01 |
| A10 = | −5.7979E+00 | −5.7667E+00 | 1.1150E+01 | −4.3207E+00 |
| A12 = | 3.3863E+00 | 6.6335E+00 | −2.9150E+01 | 2.0632E+00 |
| A14 = | 2.8502E+00 | −1.4944E+02 | −2.0460E+01 | 1.1823E+01 |
| A16 = | −2.0298E+00 | 4.6981E+02 | −2.9271E+01 | −4.8924E+01 |
| | Surface # | | | |
| | 6 | 7 | 8 | 9 |
| k = | −1.4746E+00 | −1.7795E+00 | −4.8075E+00 | −2.0364E+01 |
| A4 = | 1.5868E−01 | 5.5163E−01 | 4.6824E−02 | −1.0817E−02 |
| A6 = | 4.3164E+00 | 2.3579E+00 | −5.6132E−01 | −1.6640E−01 |
| A8 = | −1.3885E+01 | −2.2108E+00 | 8.7062E−01 | 3.3661E−02 |
| A10 = | 2.5565E+01 | 2.2203E+00 | −6.8611E−01 | 2.3560E−02 |
| A12 = | −3.3824E+01 | −2.2707E+00 | 2.8424E−01 | −1.3928E−02 |
| A14 = | 8.7486E+00 | −5.9030E+00 | −8.5715E−02 | −4.2254E−03 |
| A16 = | −2.2421E+00 | −5.2164E+00 | 2.8915E−02 | −4.4008E−03 |

In the image capturing system lens assembly according to the eighth embodiment, the equation of the aspheric surface profiles of the eighth embodiment is the same as those stated in the first embodiment. The definitions of f, Fno, HFOV, R1, R2, R7, R8, T23, CT3, f1, f2, f3 and f4 are the same as those stated in the first embodiment with corresponding values for the eighth embodiment. Moreover, these parameters can be calculated from Table 15 as the following values and satisfy the following relationships:

| | | | |
|---|---|---|---|
| f (mm) | 2.34 | f/f1 | 0.86 |
| Fno | 2.67 | R7/R8 | 1.05 |
| HFOV (deg.) | 32.0 | T23/f | 0.15 |
| (R1 + R2)/(R1 − R2) | 0.66 | CT3/f | 0.07 |
| f/f4 | 0.03 | \|f/f2\| + \|f/f3\| + \|f/f4\| | 0.16 |

### Ninth Embodiment

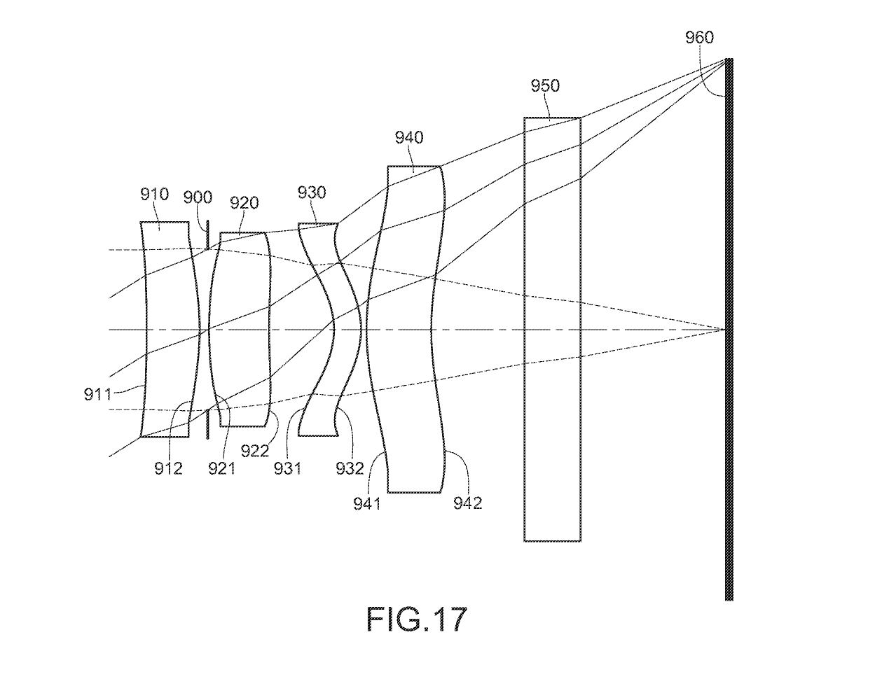

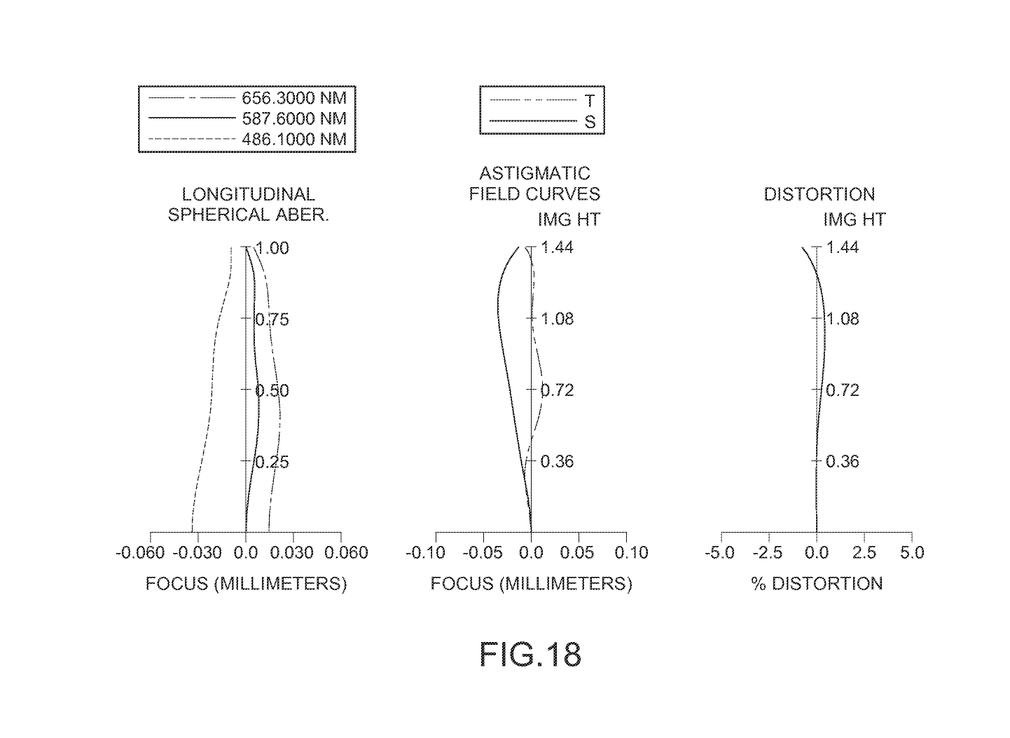

FIG. 17 is a schematic view of an image capturing system lens assembly according to the ninth embodiment of the disclosure. FIG. 18 shows spherical aberration curves, astigmatic field curves and a distortion curve of the image capturing system lens assembly according to the ninth embodiment. In FIG. 17, the image capturing system lens assembly comprises, in order from an object side to an image side, the first lens element 910, an aperture stop 900, the second lens element 920, the third lens element 930, the fourth lens element 940, an IR-cut filter 950 and an image plane 960.

The first lens element 910 with positive refractive power has a concave object-side surface 911 and a convex image-side surface 912, and is made of plastic material. The object-side surface 911 and the image-side surface 912 of the first lens element 910 are aspheric.

The second lens element 920 with positive refractive power has a convex object-side surface 921 and a concave image-side surface 922, and is made of plastic material. The object-side surface 921 and the image-side surface 922 of the second lens element 920 are aspheric.

The third lens element 930 with positive refractive power has a concave object-side surface 931 and a convex image-side surface 932, and is made of plastic material. The object-side surface 931 and the image-side surface 932 of the third lens element 930 are aspheric.

The fourth lens element 940 with positive refractive power has a convex object-side surface 941 and an image-side surface 942 being concave at a paraxial region and convex away from the paraxial region, and is made of plastic material. The object-side surface 941 and the image-side surface 942 of the fourth lens element 940 are aspheric. The fourth lens element 940 has the greatest central thickness among the lens elements with refractive powers.

The IR-cut filter 950 is made of glass material and located between the fourth lens element 940 and the image plane 960, and will not affect the focal length of the image capturing system lens assembly.

The detailed optical data of the ninth embodiment are shown in Table 17 and the aspheric surface data are shown in Table 18 below.

TABLE 17
(Embodiment 9)
f = 2.32 mm, Fno = 2.71, HFOV = 32.0 deg.

| | | Curvature | | | | | Abbe | Focal |
|---|---|---|---|---|---|---|---|---|
| Surface # | | Radius | | Thickness | Material | Index | # | Length |
| 0 | Object | Plano | | Infinity | | | | |
| 1 | Lens 1 | −12.632 | (ASP) | 0.284 | Plastic | 1.544 | 55.9 | 3.06 |
| 2 | | −1.485 | (ASP) | 0.043 | | | | |
| 3 | Ape. Stop | Plano | | 0.008 | | | | |
| 4 | Lens 2 | 2.543 | (ASP) | 0.321 | Plastic | 1.544 | 55.9 | 15.43 |
| 5 | | 3.487 | (ASP) | 0.347 | | | | |
| 6 | Lens 3 | −0.442 | (ASP) | 0.145 | Plastic | 1.634 | 23.8 | 22.08 |
| 7 | | −0.483 | (ASP) | 0.030 | | | | |
| 8 | Lens 4 | 1.498 | (ASP) | 0.346 | Plastic | 1.535 | 55.7 | 72.85 |
| 9 | | 1.433 | (ASP) | 0.500 | | | | |

| | | | | | | | |
|---|---|---|---|---|---|---|---|
| 10 | IR-Cut | Plano | 0.300 | Glass | 1.517 | 64.2 | — |
| | Filter | | | | | | |
| 11 | | Plano | 0.779 | | | | |
| 12 | Image | Plano | — | | | | |

Note:
Reference wavelength (d-line) is 587.6 nm.

TABLE 18
Aspheric Coefficients

| | Surface # | | | |
|---|---|---|---|---|
| | 1 | 2 | 4 | 5 |
| k = | 1.3364E+02 | −1.1099E+01 | 5.1943E+00 | 1.0365E+01 |
| A4 = | −3.3418E−01 | 2.9836E−01 | 7.5302E−01 | −6.7805E−01 |
| A6 = | 5.4983E−01 | −1.3527E+00 | −1.9821E+00 | −1.0673E+00 |
| A8 = | 1.4861E+00 | 6.1182E+00 | −5.7556E−02 | 5.1145E+00 |
| A10 = | −5.9898E+00 | −1.2325E+01 | 7.5232E+00 | −1.5734E+01 |
| A12 = | −8.1739E−01 | 6.6425E+00 | −2.9141E+01 | 2.0702E+00 |
| A14 = | 1.3488E+01 | −1.4944E+02 | −2.0468E+01 | 1.1836E+01 |
| A16 = | 2.4800E−01 | 4.6981E+02 | −2.9271E+01 | −4.8924E+01 |
| | Surface # | | | |
| | 6 | 7 | 8 | 9 |
| k = | −9.9077E−01 | −1.1084E+00 | −1.1341E+00 | −2.6582E+01 |
| A4 = | 4.0950E−01 | 8.1961E−01 | −1.0497E−01 | 3.1942E−02 |
| A6 = | 9.7780E+00 | 4.4590E+00 | −6.1751E−01 | −3.0308E−01 |
| A8 = | −2.2606E+01 | −9.1255E−01 | 1.1078E+00 | 9.1721E−02 |
| A10 = | 2.2107E+01 | −2.4677E+00 | −8.3680E−01 | 1.2093E−01 |
| A12 = | −3.3825E+01 | −1.3075E+01 | 2.1514E−01 | −9.8301E−02 |
| A14 = | 8.7417E+00 | −5.1515E+00 | −1.0789E−01 | −6.5277E−02 |
| A16 = | −2.2544E+00 | −5.2172E+00 | 1.4553E−01 | 4.6655E−02 |

In the image capturing system lens assembly according to the ninth embodiment, the equation of the aspheric surface profiles of the ninth embodiment is the same as those stated in the first embodiment. The definitions of f, Fno, HFOV, R1, R2, R7, R8, T23, CT3, f1, f2, f3 and f4 are the same as those stated in the first embodiment with corresponding values for the ninth embodiment. Moreover, these parameters can be calculated from Table 17 as the following values and satisfy the following relationships:

| | | | |
|---|---|---|---|
| f (mm) | 2.32 | f/f1 | 0.76 |
| Fno | 2.71 | R7/R8 | 1.05 |
| HFOV (deg.) | 32.0 | T23/f | 0.15 |
| (R1 + R2)/(R1 − R2) | 1.27 | CT3/f | 0.06 |
| f/f4 | 0.03 | \|f/f2\| + \|f/f3\| + \|f/f4\| | 0.29 |

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An image capturing system lens assembly comprising, in order from an object side to an image side:
a first lens element with positive refractive power having a convex object-side surface and a convex image-side surface;
a second lens element with positive refractive power;
a third lens element with positive refractive power;
a fourth lens element with positive refractive power having a convex object-side surface, an image-side surface being concave at a paraxial region and convex away from the paraxial region, which has both of the object-side surface and the image-side surface being aspheric;
wherein a curvature radius of the object-side surface of the first lens element is R1, and a curvature radius of the image-side surface of the first lens element is R2, the following relationship is satisfied:
−0.45<(R1+R2)/(R1−R2)<0.85.

2. The image capturing system lens assembly of claim 1, wherein the third lens element has a concave object-side surface and a convex image-side surface.

3. The image capturing system lens assembly of claim 2, wherein a focal length of the image capturing system lens assembly is f, a focal length of the second lens element is f2, a focal length of the third lens element is f3, and a focal length of the fourth lens element is f4, the following relationship is satisfied:
0<|f/f2|+|f/f3|+|/f4|<1.0.

4. The image capturing system lens assembly of claim 3, wherein the curvature radius of the object-side surface of the first lens element is R1, and the curvature radius of the image-side surface of the first lens element is R2, the following relationship is satisfied:
−0.25<(R1+R2)/(R1−R2)<0.75.

5. The image capturing system lens assembly of claim 3, wherein the focal length of the image capturing system lens assembly is f, and the focal length of the fourth lens element is f4, the following relationship is satisfied:
0<f/f4<0.5.

6. The image capturing system lens assembly of claim 3, wherein a central thickness of the first lens element is CT1, a central thickness of the second lens element is CT2, a central thickness of the third lens element is CT3, and a central thickness of the fourth lens element is CT4, the following relationships are satisfied:
CT4>CT1;
CT4>CT2; and
CT4>CT3.

7. The image capturing system lens assembly of claim 2, wherein the image capturing system lens assembly is applicable to an infrared wavelength range between 780 nm to 950 nm.

8. The image capturing system lens assembly of claim 2, wherein a focal length of the image capturing system lens assembly is f, and a focal length of the first lens element is f1, the following relationship is satisfied:
0.3<f/f1<1.0.

9. The image capturing system lens assembly of claim 8, wherein the second lens element has a convex image-side surface.

10. The image capturing system lens assembly of claim 8, wherein a curvature radius of the object-side surface of the fourth lens element is R7, and a curvature radius of the image-side surface of the fourth lens element is R8, the following relationship is satisfied:
0.9<R7/R8<1.5.

11. The image capturing system lens assembly of claim 8, wherein an axial distance between the second lens element and the third lens element is T23, and the focal length of the image capturing system lens assembly is f, the following relationship is satisfied:
0<T23/f<0.40.

12. An image capturing system lens assembly comprising, in order from an object side to an image side:
a first lens element with positive refractive power having a convex image-side surface;
a second lens element with positive refractive power;
a third lens element with positive refractive power; and
a fourth lens element with positive refractive power having a convex object-side surface and an image-side surface being concave at a paraxial region and convex away from the paraxial region, which has both of the object-side surface and the image-side surface being aspheric;
wherein a curvature radius of an object-side surface of the first lens element is R1, a curvature radius of the image-side surface of the first lens element is R2, an axial distance between the second lens element and the third lens element is T23, and a focal length of the image capturing system lens assembly is f, the following relationships are satisfied:
−0.45<(R1+R2)/(R1−R2)<1.5; and
0<T23/f<0.40.

13. The image capturing system lens assembly of claim 12, wherein the focal length of the image capturing system lens assembly is f, and a focal length of the first lens element is f1, the following relationship is satisfied:
0.3<f/f1<1.0.

14. The image capturing system lens assembly of claim 13, wherein a central thickness of the third lens element is CT3, and the focal length of the image capturing system lens assembly is f, the following relationship is satisfied:
0<CT3/f<0.25.

15. The image capturing system lens assembly of claim 13, wherein the focal length of the image capturing system lens assembly is f, a focal length of the second lens element is f2, a focal length of the third lens element is f3, and a focal length of the fourth lens element is f4, the following relationship is satisfied:
0.2<|f/f2|+|f/f3|+|f/f4|<0.8.

16. The image capturing system lens assembly of claim 13, wherein the third lens element has a concave object-side surface and a convex image-side surface.

17. The image capturing system lens assembly of claim 12, wherein the axial distance between the second lens element and the third lens element is T23, and the focal length of the image capturing system lens assembly is f, the following relationship is satisfied:
0<T23/f<0.25.

18. The image capturing system lens assembly of claim 17, wherein a curvature radius of the object-side surface of the fourth lens element is R7, and a curvature radius of the image-side surface of the fourth lens element is R8, the following relationship is satisfied:
0.9<R7/R8<1.5.

19. The image capturing system lens assembly of claim 17, wherein at least one of the object-side surface and the image-side surface of the first lens element are aspheric and the first lens element are made of plastic material, at least one of an object-side surface and an image-side surface of the second lens element are aspheric and the second lens element are made of plastic material, at least one of an object-side surface and an image-side surface of the third lens element are aspheric and the third lens element are made of plastic material, and at least one of the object-side surface and the image-side surface of the fourth lens element are aspheric and the fourth lens element are made of plastic material.

20. The image capturing system lens assembly of claim 12, wherein the image capturing system lens assembly is applicable to an infrared wavelength range between 780 nm to 950 nm.
